(19) United States
(12) Patent Application Publication
(10) Pub. No.: US 2024/0174833 A1
(43) Pub. Date: May 30, 2024

(54) FUNCTIONAL METAL-CONTAINING ARTICLES

(71) Applicant: Penn Color, Inc., Doylestown, PA (US)

(72) Inventors: Michael G. Beaver, Doylestown, PA (US); Javiera Rubilar Parra, Ambler, PA (US); Kelan Wieloch, Lansdale, PA (US); William C. Miles, Collegeville, PA (US)

(21) Appl. No.: 18/551,226

(22) PCT Filed: Mar. 25, 2022
(86) PCT No.: PCT/US22/21981

§ 371 Date: Sep. 19, 2023

Related U.S. Application Data
(60) Provisional application No. 63/165,803, filed on Mar. 25, 2021.

(51) Int. Cl. C08K 3/22; C08K 3/16; C09D 5/14; C09D 133/08; C09D 175/04

(52) U.S. Cl. CPC C08K 3/22; C08K 3/16; C09D 5/14; C09D 133/08; C09D 175/04; C08K 2003/162; C08K 2003/2248

(57) ABSTRACT

The disclosure relates to a functional article made from a functional composition that includes a polymer, functional metal, and halide salt, wherein the functional article possesses both a functional property (e.g., antimicrobial properties) and a desirable color and/or opacity.

### FIELD

The present disclosure relates to compositions for forming functional articles, such as melt-mixed and formed or deposited as a film, that contain functional metal additives and have additional additives that reduce the color contribution of the functional metal additives to the article's appearance.

### BACKGROUND

In the world of products that are purchased by or interact with consumers, appearance is important for branding, trade dress and consumer experience. Modern consumers demand products that are eye-catching and aesthetically pleasing. Oftentimes merely having a product that achieves some functional benefit is not enough if the aesthetics of the product do not meet the market's expectations. For example, copper-containing materials are well known for their antimicrobial properties, but copper often imparts a metallic and/or brown color that can be undesirable. Many such products or articles are made using polymers. Sometimes these products or articles are made with active ingredients delivered as a powder, polymer compound or polymer masterbatch to be melt-mixed with additional polymer and formed into a final part, such as, for example, a PET beverage bottle. Other times, these articles are formed by coating a surface with a polymeric film deposited in a liquid (solvent, water or energy curable form) that is then cured onto that surface and imparts the desired functionality, such as, for example, a protective layer over a printed vinyl surface. A particular solution may be chosen over another because it provides the best balance between functional benefit and appearance. An example of this might be using an organic UV blocker in a clear part rather than a mineral-based UV blocker (for example, ZnO) because of the opacity that the mineral produces when incorporated into the part.

One aspect of appearance is color, which can be described mathematically. For example, the CIELAB L*, a*, b* color space describes mathematically all perceivable colors in three dimensions: L* for lightness, a* for green-red, and b* for blue-yellow. See Hunter Lab, Applications Note, “Insight on Color,” Vol. 8, No. 7 (2008). In the CIELAB color space, the L* axis runs from top to bottom. The maximum L* value is 100, which indicates a perfect reflecting diffuser (i.e., the lightest white). The minimum L* value is 0, which indicates a perfect absorber (i.e., the darkest black). Positive a* is red. Negative a* is green. Positive b* is yellow. Negative b* is blue. CIELAB a* or b* values equal to 0 indicate no red-green or blue-yellow color appearance, in which case the article would appear achromatic. In contrast, a* or b* values that deviate far from 0 indicate that light is non-uniformly absorbed or reflected. As a* or b* values deviate from 0, the color may no longer appear neutral. One of the most important attributes of the CIELAB model is device independence, which means that the colors are defined independent of their nature of creation or the device they are displayed on.

CIELAB can also be mathematically described in polar coordinates, also called CIE LCh. In CIE LCh, the L* value is for lightness. C* is chroma or relative saturation, which is defined as V(a*²+b*²). A C* value of 0 is achromatic, and higher C* values indicate more saturated color. The h° value is hue angle and relates to the color around the polar coordinate. An h° of 0° is red; an h° of 90° is yellow; an h° of 180° is green; and an h° of 270° is blue.

Another aspect of the appearance is opacity, or barrier to light. This can be desirable if there is a need to obscure light from affecting the contents contained within an article or a package or to prevent quality degradation of a product during a period of time between packaging and use. Milk, for example, can be damaged by the photochemical and ionizing effects of light. In other situations, however, opacity may be undesirable, as obscuring light from passing through an article can decrease the overall available color space. This is particularly true for high refractive index materials that also impart a color that is not white, as that can result in a dirty or unclean appearance. The trade-off between opacity and color is critical to understand when a material is added for some functional purpose and increases opacity of an article. Opacity is a common and well-understood measurement used to determine the ability of light to pass through a material.

In recent years widespread attention has focused on the consequences of microorganism contamination of surfaces. Microbial life exists everywhere and is often difficult to control. Bacteria, viruses, molds, and fungi are characterized by the ability to easily spread and quickly reproduce, oftentimes in conditions which would normally destroy other lifeforms. Some of these organisms are responsible for human disease, so controlling their growth and spread is paramount to ensuring public health and safety. These potentially pathogenic microbes such as bacteria, viruses, molds, and fungi, have been observed in many locations and industries such as textiles, healthcare products, medical devices, water purification systems, food, food packaging, home and office furniture, shared touch points such as light switches, buttons, automotive interiors, safety equipment, clothing, and sanitation facilities. The actual number of bacterial infections acquired through contaminated surfaces is not presently known, but is accepted to be significant. Many medical devices cannot be properly sterilized, and they are exposed to environments containing bacteria. Sutures, catheters, face masks, gloves, surgical tape, and certain medical instruments cannot be autoclaved, but must be used in areas where pathogenic bacteria are encountered. It would be advantageous to render these types of medical devices antibacterial and self-sterilizing, and there has been tremendous effort to develop materials that possess these self-disinfecting properties.

For many centuries the antimicrobial properties of various metals and their corresponding salts has been known and exploited. This so-called “oligo dynamic effect” is not precisely understood, but qualitatively describes the biocidal properties of many metals such as gold, silver, copper, and zinc. Silver is used as an antimicrobial agent in wound dressings, creams, and as coatings for medical devices. Copper has been used since the times of Ancient Egypt where it was used to sterilize water. In recent years, much focus has been placed on incorporating these oligo dynamic metal particles such as silver or copper into a polymer to produce antimicrobial materials. Controlling the oxidation state of the metal is critical for imparting antimicrobial properties into these polymer composites. It has been well documented that silver's antimicrobial properties stem from its ionized form Ag⁺, which has the ability to form strong molecular bonds with substances that bacteria use to respire, rendering them inactive and leading to the cell's death. Copper, while less well understood, has had the mechanism of its antimicrobial properties explained as causing direct cell damage, generation of radical hydroxyl species, or entry of copper ions into the cell which disrupts the function of DNA and RNA. While the exact mechanism of copper's antimicrobial action is unclear, it has been shown that Cu¹⁺ ions are considerably more toxic to bacteria than Cu²⁺ ions under test conditions that mimic bacterial growth on common surfaces.

US 2020/0123395 discusses the disadvantages of copper with respect to color, stating that “copper is highly colored and may not be used when a white or colorless material is desired. Colorants may be added to adjust the color, but often results in muted colors or a cream or non-white color.” While copper oxide (a functional metal with a refractive index different than a bulk film and light absorption that contributes to color) is incorporated for its antimicrobial functionality, it imparts an undesirable aesthetic component.

Thus, there is a need for functional metal to be used in an article in a manner that maximizes the desired functional effect, while decreasing or eliminating the aesthetic disadvantages to using that functional metal, particularly at desired concentrations.

### SUMMARY

In one aspect, the disclosed technology relates to a functional article including a composition including: a polymer; copper oxide; and a halide salt; wherein the molar ratio of halide salt to copper oxide in the composition is about 0.01 to about 100; and wherein the article has an enhanced property selected from at least one of the following properties as compared to an article including a composition that differs only by the absence of the halide salt: (a) a color difference measured as DE_{CMC} of more than 0.5 units; (b) increased antimicrobial efficacy; (c) reduced opacity; (d) reduced haze; and (e) increased whiteness. In some embodiments, the polymer is a thermoplastic. In some embodiments, the thermoplastic includes nylon, polyvinylchloride, or a combination thereof. In some embodiments, the polymer is a thermoset polymer and the composition is a cured coating. In some embodiments, the thermoset polymer includes an acrylic or polyurethane. In some embodiments, the copper oxide is contained within a ceramic. In some embodiments, the copper oxide is contained within a glass ceramic matrix. In some embodiments, the copper oxide is derived from cuprous oxide.

In some embodiments, the halide salt is selected from at least one of potassium iodide, potassium bromide, magnesium chloride, potassium chloride, sodium chloride, sodium iodide, and calcium chloride. In some embodiments, the halide salt is potassium iodide. In some embodiments, the composition includes about 0.01 wt % to about 10 wt % copper oxide, based on the total weight of the composition. In some embodiments, the composition includes about 0.01 wt % to about 10 wt % halide salt, based on the total weight of the composition. In some embodiments, the molar ratio of halide salt to copper oxide is about 0.1 to about 10. In some embodiments, the composition further includes a colorant.

In some embodiments, a color difference measured as DE_{CMC} between the functional article and an article including a composition that differs only by the absence of the halide salt is more than 0.5 units. In some embodiments, the composition exhibits antimicrobial activity that is at least 0.25 log greater than a composition that differs only by the absence of the halide salt. In some embodiments, the composition is less opaque than a composition that differs only by the absence of the halide salt. In some embodiments, the composition exhibits less haze than a composition that differs only by the absence of the halide salt. In some embodiments, the composition is whiter than a composition that differs only by the absence of the halide salt. In some embodiments, the article is selected from a bottle, pouch, fibers, film, sheet, and container.

In another aspect, the disclosed technology relates to a compound including: a thermoplastic; copper oxide; and a halide salt; wherein the molar ratio of halide salt to copper oxide in the compound is about 0.01 to about 100.

In another aspect, the disclosed technology relates to a method of producing an antimicrobial article, including: (a) preparing a composition including: (i) a thermoplastic or thermoset polymer; (ii) copper oxide; (iii) and a halide salt; wherein the composition exhibits at least a 1 log reduction in concentration of Escherichia coli using a modified ISO 22196 test method; and (b) forming an antimicrobial article from the composition. In some embodiments, (i) the composition includes a thermoplastic, and step (b) includes extruding the composition to produce the antimicrobial article; or (ii) the composition includes a thermoset polymer, and step (b) includes formulating the composition with a liquid carrier to form an antimicrobial liquid dispersion, depositing the antimicrobial liquid dispersion onto an article to form an antimicrobial liquid layer, and curing the antimicrobial liquid layer to form the antimicrobial article including an antimicrobial film.

In some embodiments, a color difference measured as DE_{CMC} between the article and an article having a composition that differs only by the absence of the halide salt is more than 0.5 units. In some embodiments, a color difference measured as DE_{CMC} between the article and an article having a composition that differs only by the absence of the copper oxide and halide salt is less than a color difference measured as DE_{CMC} between an article having a composition that differs only by the absence of the halide salt and an article having a composition that differs only by the absence of the copper oxide and halide salt.

### DETAILED DESCRIPTION

The present disclosure relates to functional articles and compositions for forming such functional articles, such as compositions that are melt-mixed and formed (e.g., injection molded parts, extruded sheets, extruded and melt-blown fibers, extruded films) or deposited as a film (e.g., solvent-borne, water-borne, energy curable liquid coatings), that contain functional metal additives and have additional additives that reduce the color contribution of the functional metal additives to the article's appearance.

The following discussion includes various embodiments that do not limit the scope of the appended claims. Any examples set forth herein are intended to be non-limiting and merely illustrate some of the many possible embodiments of the disclosure. Further, particular features described herein can be used in combination with other described features in each of the various possible combinations and permutations. Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and claims, the singular forms “a,” “an,” and “the” include plural referents unless otherwise specified, and that the terms “includes” and/or “including,” when used in this specification, specify the presence of stated features, steps, elements, and/or components, but do not preclude the presence or addition of one or more other features, steps, elements, components, and/or combinations thereof. All publications mentioned herein are hereby incorporated by reference in their entirety unless otherwise stated.

As used herein, “function” or “functionality” refers to the action for which a material is specifically fitted or used or for which a material exists. For instance, the functionality of a material relates to the property or properties that the material possesses that differentiate it from another material. Some illustrative examples of a functionality include an antimicrobial article compared to an article that does not possess any substantial or measurable antimicrobial properties, or an article with UV blocking capabilities compared to one that does not possess any substantial or measurable ability to block UV light.

For polymeric materials, this functionality may be delivered through metal-containing materials (referred to herein as either “functional metals” or “metals”). In general, functional metals are incorporated into the disclosed articles via melt mixing, or are deposited on top of the article via film deposition to impart the desired functional benefit to the article. The functional benefits that can be imparted or altered by incorporation of functional metals in this way are wide and varied, and include but are not limited to one or more of: antimicrobial properties, antiviral properties, electrical conductivity, electrical insulation, thermal conductivity, thermal insulation, optical density, ultraviolet light blocking, IR absorption, IR reflection, catalytic reactivity such a NOx destruction, oxygen scavenging, anti-oxidants, hydroperoxide scavenging, free radical scavenging, flame retardancy, smoke suppression, adhesion promotion, odor scavenging, odor absorption, crystal nucleation, rigidity enhancement, plasticizers and thermal stabilization. Essentially, the polymeric material serves as a carrier and/or structure that allows incorporation of the functional metal into or on top of the article, and thus enables these types of functional metals to provide functionalities that differentiate the article in some significant way.

Some examples of functional metals include but are not limited to gold, titanium, platinum, tin, copper, zinc, and silver and their alloys, and combinations thereof. The functional metal may contain inorganic or organic structures and includes metal oxides, metal halides, metal carbonates, metal acetates, metal sulfates, metal oxalate, metal nitrate, metal nitride, metal phosphate, metal stearate, metal hydride, metal hydroxide, metal thiocyanates, or a mixed metal version of these compounds and/or similar types of compounds.

The incorporation of functional metals into various articles (referred to herein as “functional articles,” further described below) provides the article with a differentiating characteristic in its end-use. However, often the functional metals described herein are characterized by a higher refractive index than the polymer in which they are being incorporated and a particular color value that is imparted to the functional article as well. Thus, incorporation of the metals into a functional article imparts that article with both some level of color and opacity, which may be undesirable. Generally, as the concentration of functional metal in the final part is increased, the level of opacity and the impact on the color of the functional article also increases. This creates an inherent trade-off where maximizing the functionality achieved by inclusion of the functional metal comes at a cost to the aesthetics of the resulting article, while providing optimal aesthetics comes at a cost to the function of the article. To mitigate this trade-off, the disclosed compositions include a halide salt, as described below.

The disclosed articles are made from compositions comprising a polymer, a functional metal additive and a halide salt. Surprisingly, it has been discovered that using a combination of functional metals and a halide salt in a polymer may eliminate the tradeoff between appearance and functional benefit of the functional metal. The article may combine an increased concentration of functional metal additive with a decreased contribution of that metal additive on the functional article's opacity and color. This enables more of the metal to be added without sacrificing article functionality or aesthetics. Alternatively, the aesthetics do not hinder the ability to color the article or may not hinder the desire for a white or transparent appearance despite the presence of the functional metal. Without being bound by any particular theory, it is believed that the metal additive has a relatively low solubility in the polymer. Introducing the halide salt shifts the equilibrium to increase the amount of metal additive that is soluble in the polymer and decreases the impact that the metal additive has on the opacity and color of the functional article. The increased solubility may further increase migration of the functional metal throughout the polymer. This surprising result is not limited to one type of polymer or one type of metal additive and is understood to be applicable to multiple types of systems, including melt- mixed and extruded systems as well as coatings that are formulated and then deposited onto a desired surface.

Opacity can be measured several ways. It may be measured in plastic articles or free films as:

Opacity=100−%LightTransmission

The % Light Transmission can be measured over a range of wavelengths, for example wavelengths visible to the human eye, about 400 nm to about 700 nm. Opacity can also extend beyond the range visible to the human eye to include ultraviolet and infrared wavelengths. A variety of instruments can measure opacity, such as spectrophotometers, colorimeters, densitometers, or photodiodes. In some embodiments, opacity is characterized as a measure of optical density, which is the −log₁₀ of the ratio of light passing through a sample. For paint, coatings, or drawn downs, opacity may alternatively be measured as contrast ratio, which is the ratio of reflected light of a coating as measured over a black background, R₀, divided by the reflectance of the same coating, as measured over a white background, R_{W}. A Contrast Ratio of 100% is fully opaque, and a Contrast Ratio of 0% is completely transparent with no opacity.

$$Contrast Ratio = \frac{{R}_{0}}{{R}_{W}}$$

### Functional Articles

In some embodiments, the functional articles disclosed herein are generally formed by melt-mixing a disclosed composition and then extruding the mixture to form a thermoplastic product, whereby the composition imparts the resulting functional article product with the desired antimicrobial properties and appearance described herein. Non-limiting examples of functional articles that are thermoplastic products include bottles and other containers, sheets, thermoformed parts, pouches, fibers, and packages for containing various consumer products. In some embodiments, the functional thermoplastic product may have an internal volume of about 10 ml to about 5000 ml, about 50 ml to about 4000 ml, about 100 ml to about 2000 ml, about 200 ml to about 1000 ml, or about 10 ml to about 250 ml.

In other embodiments, the functional articles disclosed herein are formed by formulating the composition in a liquid dispersion and then depositing that liquid onto a substrate (e.g., article) to form a liquid layer that is then cured, thus yielding an article having a functional film coating, whereby the film imparts the article with the desired antimicrobial properties and appearance described herein. In some embodiments, the functional film may have a thickness of about 0.001 mm to about 5 mm, about .001 mm to about 4 mm , about 0.001 to about 3.5 mm, about 0.001 mm to about 3 mm, about 0.001 mm to about 2 mm, or to about 0.001 mm to about 1 mm.

Weight percentages of components included in the disclosed compositions are generally described herein as being based on the total weight of the composition, which is the same as being based on the total weight of an uncured layer or other portion of the article in which the composition is present, rather than being based on the total weight of the whole article unless, of course, the whole article is formed of a single layer of the composition without any accessories or attachments (e.g., labels, caps, non-polymeric layers, etc.).

### Functional Metal Additives

In this disclosure, “functional metal additives” or “functional metals” are defined as materials that contain some metal component and provide a functional benefit to the article within which they are formulated. Some examples of “functional metals” include but are not limited to gold, titanium, platinum, tin, copper, zinc, and silver and their alloys, with copper being the most preferable. The functional metal may contain inorganic or organic structures, and may include metal oxides, metal halides, metal carbonates, metal acetates, metal sulfates, metal oxalate, metal nitrate, metal nitride, metal phosphate, metal stearate, metal hydride, metal hydroxide, metal thiocyanates, or even a mixed metal version of these types of compounds. Metal oxides are the most preferred form of functional metal, with particular emphasis on the oxides of copper. Copper oxide may herein be used to refer to either of the two compounds copper forms with oxygen which depends on the valence state of the copper. These two forms include copper in the +1 valence state (Cu¹⁺) from which it forms cuprous oxide (Cu₂O), and copper in the +2 valence state (Cu²⁺) from which it forms cupric oxide (CuO). This includes each of these materials individually, and also mixtures of the two. In some embodiments, the functional metal is copper oxide and/or zinc oxide.

In some embodiments of the present disclosure, the functional metal is directly incorporated into the polymer by melt processing or other methods known by those skilled in the art of polymer processing. In other embodiments, the functional metals may be preloaded into a carrier particle and then incorporated into the polymer by melt processing or other methods known by those skilled in the art of polymer processing. The carrier particle may be a porous or non-porous material, and the carrier particle may be of any shape or size including but not limited to spherical, irregular, or cylindrical shape. Examples of potential carrier particles include but are not limited to glass structures, zeolites, aluminosilicates, precipitated silicas, and mesoporous silicas. One example of this structure is GUARDIANT® (Corning, Inc.), which are particles of an alkali copper aluminoborophosphosilicate glass ceramic material that acts as a sustainable delivery system for Cu⁺¹ ions with high antimicrobial efficacy and contains approximately 26% cuprite and 74% glass ceramic by weight.

In some embodiments, the article comprises a composition that includes the functional metal additive in an amount of at least 0.01 wt %, at least 0.1 wt %, at least 0.5 wt %, at least 1.0 wt %, at least 1.5 wt %, at least 2.0 wt %, at least 2.5 wt %, at least 3.0 wt %, at least 3.5 wt %, at least 4.0 wt %, at least 4.5 wt %, or at least 5.0 wt %, based on the total weight of the composition. In some embodiments, the amount of functional metal additive in the composition is about 0.01 wt % to about 10 wt %, such as about 0.1 wt % to about 8 wt %, about 0.5 wt % to about 6 wt %, o about 1 wt % to about 5 wt %, about 1 wt % to about 4 wt %, or about 1 wt % to about 3 wt %, based on the total weight of the composition.

### Halide Salt

A halide salt is defined as a compound comprising a cation and a halogen anion, such as sodium chloride or potassium iodide. In some embodiments, the halide salt is a water soluble halide salt, such as potassium iodide, potassium bromide, magnesium chloride, sodium iodide, or sodium chloride. Halide salts may be of an inorganic nature such as sodium chloride and calcium chloride or of an organic nature such as 1,3-dimethylimidazolium iodide. Chlorine, bromine and iodine anions form the vast majority of commercially available halide salts. In some embodiments, the inorganic halide salt is an alkali halide salt of group 1 or 2 metals such as but not limited to potassium iodide or calcium chloride. In some embodiments, the inorganic halide salt is a transition metal halide salt of groups 3-12 such as copper(II) chloride or silver(I) chloride. In some embodiments, the halide salt is an organic halide salt such as but not limited to 1,3-dimethylimidazolium iodide or 4-Amino-N-laurylpyridiniium chloride (ALPC). In some embodiments, the halogen is iodine. Iodine can be used in various forms such as, but not limited to elemental iodine, potassium iodide, povidone-iodide, cadexomer iodine, or sodium iodide. In some embodiments, the halogens are astatine or tennessine. There also exist metal compounds containing more than a single cation, containing more than a single anion, or containing more than a single cation and more than a single anion. As an example, consider a mixed metal halide material of this type of having two metals with a common anion that may be expresses as M₁-M₂ (X), where M₁ is the first metal, M₂ is the second metal, and X is the anion (halide in this particular case). Another possible combination is M₁-M₂ (X₁-X₂) where X₁ and X₂ are different anions.

Halide salts have a wide range of solubility and compatibility within various matrices. For example, potassium iodide has a water solubility of 1400 g/L at 20° C. while lead (II) chloride has a water solubility of 0.99 g/L at 20° C. Thus, selection of an appropriate halide salt for the given polymer in which the functional metal is contained is dependent on the properties of the polymer matrix.

Without being bound by any particular theory, these halide salts contain anions which are believed to increase the solubility of the functional metal into the polymer. Because the halide salts typically do not exhibit opacity on their own and have little to no color, and because they decrease the opacifying effect of the functional metal by increasing its solubility in the polymer, the overall contribution to opacity and/or color of the functional metal combined with the halide salt is less than the contribution to opacity and/or color of the functional metal alone.

In some embodiments, the article comprises a composition that includes the halide salt in an amount of at least 0.01 wt %, at least 0.1 wt %, at least 0.5 wt %, at least 1.0 wt %, at least 1.5 wt %, at least 2.0 wt %, at least 2.5 wt %, at least 3.0 wt %, at least 3.5 wt %, at least 4.0 wt %, at least 4.5 wt %, at least 5.0 wt %, at least 10 wt %, at least 50 wt %, or at least 75 wt %, based on the total weight of the composition.

In some embodiments, the article comprises a composition that includes the halide salt in an amount of at most 0.01 wt %, at most 0.1 wt %, at most 0.5 wt %, at most 1.0 wt %, at most 1.5 wt %, at most 2.0 wt %, at most 2.5 wt %, at most 3.0 wt %, at most 3.5 wt %, at most 4.0 wt %, at most 4.5 wt %, at most 5.0 wt %, at most 10 wt %, at most 50 wt %, or at most 75 wt %, based on the total weight of the composition.

### Metal to Halide Molar Ratio

The halide salt, such as potassium iodide (KI), has a high solubility in water and the polymer. Without being bound by any theory, it is believed that when the metal compounds and KI are mixed together during melt processing of the polymer or in solution with the polymer, the KI dissolves and forms K⁺ and I⁻ ions in the polymer or solution. The exact mechanism is unknown within the polymer system, but the presence of I⁻ may allow the metal compound to solubilize in the polymer. Many metal cations are not stable and so the presence of the iodide anion is believed to help enhance stability. This is particularly true in certain polymers—e.g., nylon and polyurethane—which contain amide groups with available free electrons that may help stabilize these species. Once the functional metal has been solubilized into the polymer, its contribution to the color and opacity of the article decreases significantly, resulting in a more transparent material that not only has the desired functional properties, but also the ability to enhance the available color space and aesthetics of the final article considerably. Le Chatlier's Principle states that by increasing the amount of iodide anion in the article, the resulting equilibrium reaction will be driven to favor the formation of a soluble functional metal ion. Thus, higher amounts of iodide anion present will drive the dissolution of the functional metal into the polymer. Because different amounts of the functional metal are desired for different applications, it is helpful to define its usage not just in weight percentage in final but based on a molar ratio in relation to the halide salt added to the system. In this case, that molar ratio, R, is as follows:

$$R = \frac{mol halogen}{mol elemental metal}$$

By selecting the proper molar ratio, R, the opacity and color contribution of the functional metal in the final article can be controlled. The molar ratio R may be used to describe the quantity of halide salt added to the system.

In some embodiments, it has been observed that if one places a Nylon 6 plaque that has been mixed with only KI during melt processing in an aqueous bath, UV-VIS light absorption readings can detect the presence of I in the soaking solution, as the I⁻ migrates through the polymer and into solution. The amount of I present in the soaking solution is dependent on the concentration of I⁻ present in the polymer. A similar trend is found for polymer samples containing both copper oxide and KI. In this case, copper might also be detected in the soaking solution due to the enhanced availability from the presence of the halide.

In some embodiments, the composition includes the molar ratio, R, of the halide anion to functional metal in a range of about 0.01 to about 100, about 0.1 to about 75, about 0.1 to about 50, about 0.1 to about 25, or about 0.1 to about 10. In some embodiments, the molar ratio R has a minimum value. In some embodiments, the value R may be at least 0.01, at least 0.05, at least 0.1, at least 0.5, at least 1.0, at least 2.0, at least 5.0, at least 10.0, at least 25.0, at least 50.0, or at least 100.0. In some embodiments, the molar ratio R, preferably has a maximum value to maintain an excess of metal. This may be necessary to maintain a reservoir of metal and control the solubility with the halide salt. In some embodiments, the value of R may be at most 0.01, at most 0.05, at most 0.1, at most, 0.5, at most 1.0, at most 2.0, at most 2.0, at most 5.0, at most 10.0, at most 25.0, at most 50.0, or at most 100.0.

Finished polymer parts can be obtained through one of many different processing schemes, including injection molding, blow molding, film extrusion, oriented films, fiber spinning, and profile extrusion. Active components, such as the functional additive, halide salt, and optionally other components such as colorants, stabilizers, dispersants, nucleating agents, or waxes of the final part are generally premixed together in a twin-screw extruder to produce a master batch. It would be desirable to incorporate the functional metal particles into a masterbatch, prior to formation of the final part. The metal compound and halide salts are mixed together with a polymer during melt processing in a twin screw extruder to produce a concentrated master batch. The master batch is then subsequently diluted in the desired final product by adding the masterbatch to the polymer of interest (e.g., nylon, such as nylon 6) in subsequent processing steps. The final article would contain the proper amounts of active functional metal and halide to preserve the functional properties of the product for an extended period of time.

### Polymer

The present disclosure relates to articles made from or with polymers, manufactured both from the melt and from depositing of a liquid. When the article is melt-mixed, the composition of the article is defined as a weight percent based on the total weight of the article. When the article is deposited from a liquid, the composition of the article is measured relative to the total weight of the uncured liquid film rather than the entire article itself.

In some embodiments, the articles made from the melt are constructed using polymers with thermoplastic character, or the ability to be melted down and re-shaped into different forms. These include polyvinylchloride (PVC), polystyrene, olefins, such as polyethylene and polypropylene, polyesters, such as polyethyleneterepthalate, polybutyleneterepthalate, or polylactide, thermoplastic urethanes, such as polyether or polyester type urethanes, and polyamides, such as nylon 6, nylon 12, or nylon 6/6. In some embodiments, the polymer is a polyamide. The polyamide family of polymers (colloquially called “Nylon”) consists of a polymer with repeating units linked by amide bonds. They are called engineering polymers due to their excellent balance of properties which stem from their inherently strong intermolecular forces. Nylons are produced through a polycondensation reaction of an amine with a carboxylic acid. Several different types of Nylon exist, including the common Nylon 6 which is produced via a ring opening polymerization of caprolactam. Other forms of Nylon such as nylon 4/6, 6/6, 6/10, 6/12 may use diamines (such as m-xylene or hexamethylenediamine) and dicarboxylic acids (such as sebacic acid, isophthalic acid, or terephthalic acid). Without being bound by any particular theory, this technology applies to any form or copolymer of nylon so long as it is capable of incorporating a metal compound and a halide to provide less color than the metal compound alone. One characteristic of nylons are that they are sensitive to water due to the hydrogen bonding ability of the amide group. It has been observed that water absorption decreases with decreasing concentration of amide group in the polymer backbone. Water acts as a plasticizer, which increases toughness and flexibility while reducing tensile strength and modulus. The absorption of moisture results in a deterioration of electrical properties and poor dimensional stability in environments of changing relative humidity. Therefore, care must be taken to reduce the water content of nylon polymer to acceptable levels before melt processing to avoid surface imperfections and embrittlement due to hydrolytic degradation.

In some embodiments of the present disclosure, the functional metal and halide salt are contained within a homogenous polymer network, while in other embodiments they are contained in a heterogeneous polymer network. An interesting class of materials are migratory or blooming amide waxes. These materials are obtained when fatty acids react with amines and diamines, and include but are not limited to Ethylene Bis-Stearamide (EBS) waxes, Euracamice waxes, Oleamide waxes, and Stearamide waxes. Amide waxes are characterized by a polar region near the amide functionality and a non-polar region near the fatty acid chain, and are incompatible with most solvents and polymer systems. Once these materials have been incorporated into polymers, they migrate to the surface, coating the article with a layer of the amide wax. These classes of materials contain similar chemical functionality to nylon, and it may be possible to incorporate the functional metal and halide salt into the amide waxes as is done with nylon or other thermoplastics. For polymer systems where the functional metal and halide salt are not soluble, an amide wax pre-loaded with the functional metal and halide salt can be used. The wax could migrate to the article surface, incorporating the desired functionality and also allowing for the control of the color space of final products made by this method.

In some embodiments of the present disclosure, the functional article is made in the form of a film that is made by coating a substrate with a liquid dispersion containing the polymer, functional metal and halide salt and then curing, usually through either heat or UV energy. These liquid dispersions can be manufactured in a liquid carrier. For the purposes of this disclosure, a liquid carrier is defined as a liquid material that enables the mixing of and deposition of the composition components onto a substrate to then be cured into a film. The liquid carriers can be either non-polar, polar aprotic and polar protic materials. This includes pentane, hexane, benzene, toluene, 1,4 dioxane, diethyl ether, tetrahydrofuran, chloroform, dichloromethane, ethyl acetate, acetone, dimethylformamide, acetonitrile, dimethylsulfoxide, nitromethane, propylene carbonate, ammonia, formic acid, n-butanol, isopropyl alcohol, n-propanol, ethanol, methanol, acetic acid and water.

In some embodiments of the present disclosure, the liquid carrier is a monomer. A “monomer” refers to organic compounds having a relatively low molecular weight (e.g., generally less than 200 Da or M_{w} of 200 grams per mole), and which may undergo chemical self-reaction (e.g., polymerization) or chemical reaction with other monomers (e.g., copolymerization) to form longer chain oligomers, polymers and copolymers. Monomers typically are unsaturated organic compounds, i.e., compounds having at least one carbon-carbon double bond. In some embodiments, the monomers are radiation curable.

With respect to films or coatings, the monomer functions in part to reduce the viscosity of liquid compositions, improve flexibility, control cure speed, and adjust for desired application and film performance properties such as, for example, hardness, adhesion, chemical resistance or reduced shrinkage. Non-limiting examples of suitable monomer classes for use in the disclosed compositions include mono-, di- and multi-functional acrylates, methacrylates, styrenes, caproplactams, prrolidones, formamids, silanes and vinyl ethers. Non-limiting examples of suitable monomers for use in the disclosed compositions include isophoryl acrylate, isodecyl acrylate, tridecyl acrylate, lauryl acrylate, 2-(2-ethoxy-ethoxy)ethyl acrylate, tetrahydrofurfuryl acrylate, propoxylated acrylate, tetrahydrofurfuryl methacrylate, 2-phenoxyethyl methacrylate, isobornyl methacrylate, 3,3,5-trimethylcyclohexyl methacrylate, octyl decyl acrylate, tridecyl acrylate, isodecyl methacrylate, stearyl acrylate, stearyl methacrylate, 1,12 dodecane diol diacrylate, 1,3-butylene glycol diacrylate, 1,4-butanediol diacrylate, 1,6-hexanediol diacrylate, alkoxylated hexanediol diacrylate, alkoxylated neopentyl glycol diacrylate, cyclohexane dimethanol diacrylate, diethylene glycol diacrylate, phenoxyethyl acrylate (POEA), 4-t-butylcyclohexyll acrylate, methacrylate butyl (BMA), butanediol-mono-acrylate, trimethylolpropanformal acrylate, tripropyleneglycol diacrylate (TPGDA), dipropyleneglycol diacrylate (DPGDA), hexanediol diacrylate (HDDA), isobornyl acrylate (IBOA), neopentylgloycol diacrylate (NPGDA), trimethylolopropan triacrylate (TMPTA), and combinations thereof.

In some embodiments, the composition includes a reactive diluent or liquid carrier, such as butyl methacrylate. In some embodiments, the reactive diluent is selected from an alkyl (meth)acrylate monomer and a polyfunctional (meth)acrylate monomer. The alkyl (meth)acrylate compound may be an alkyl (meth)acrylate wherein the alkyl group has 1 to 20 carbon atoms. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, etc. These can be used singly as one species or in a combination of two or more species.

Polyfunctional (meth)acrylate monomers include difunctional and trifunctional (meth)acrylates. Suitable, illustrative difunctional (meth)acrylates include 1,12 dodecane diol diacrylate, 1,3-butylene glycol diacrylate, 1,4-butanediol diacrylate, 1,6-hexanediol diacrylate (e.g., SR238B from Sartomer Chemical Co.), alkoxylated hexanediol diacrylate, alkoxylated neopentyl glycol diacrylate, cyclohexane dimethanol diacrylate, diethylene glycol diacrylate (e.g., SR230 from Sartomer Chemical Co.), ethoxylated (4) bisphenol A diacrylate (e.g., SR601 from Sartomer Chemical Co.), neopentyl glycol diacrylate, polyethylene glycol (400) diacrylate (e.g., SR344 from Sartomer Chemical Co.), propoxylated (2) neopentyl glycol diacrylate (e.g., SR9003B from Sartomer Chemical Co.), tetraethylene glycol diacrylate (e.g., SR268 from Sartomer Chemical Co.), tricyclodecane dimethanol diacrylate (e.g., SR833S from Sartomer Chemical Co.), triethylene glycol diacrylate (e.g., SR272 from Sartomer Chemical Co.), and tripropylene glycol diacrylate.

In some embodiments, the compositions disclosed herein may be applied to any substrate or portion of an article on which liquids and coatings may be suitably applied, including porous materials. In general, the disclosed compositions are formulated with a liquid carrier prior to being deposited onto or applied to a substrate. Upon application of liquid carrier droplets onto a porous substrate, the liquid wets the substrate, the liquid penetrates into the substrate, volatile components of the liquid evaporate or cure, leaving a dry mark on the substrate. Examples of porous substrates include paper, paperboard, cardboard, woven fabrics, and non-woven fabrics.

The compositions disclosed herein may be also successfully applied to non-porous substrates. Examples of non-porous substrates include glossy coated paper, glass, ceramics, polymeric substrate, and metal.

Non-limiting examples of polymeric substrates include polyolefin, polystyrene, polyvinyl chloride, nylon, polyethylene terephthalate, high-density polyethylene, low-density polyethylene, polypropylene, polyester, polyvinylidene chloride, urea-formaldehyde, polyamides, high impact polystyrene, polycarbonate, polyurethane, phenol formaldehyde, melamine formaldehyde, polyetheretherketone, polyetherimide, polylactic acid, polymethyl methacrylate, and polytetrafluoroethylene.

Non-limiting examples of metal substrates include base metals, ferrous metals, precious metals, noble metals, copper, aluminum, steel, zinc, tin, lead, and any alloys thereof.

Non-limiting examples of high surface energy substrates include phenolic, Nylon, alkyd enamel, polyester, epoxy, polyurethane, acrylonitrile butadiene styrene copolymer, polycarbonate, rigid polyvinyl chloride, and acrylic.

Non-limiting examples of low surface energy substrates include polyvinyl alcohol, polystyrene, acetal, ethylene-vinyl acetate, polyethylene, polypropylene, polyvinyl fluoride, and polytetrafluoroethylene. Upon application to a low surface energy substrate, the volatizable components of the liquid or ink evaporate to yield a coating on the substrate. Such a coating is resistant to water or cleaning solvents.

One or more additional components may optionally be included in the compositions for making the disclosed articles. For example, a liquid carrier composition applied to a substrate to form the disclosed article herein may contain one or more additives or fillers known in the art for use in coatings. Such coating additives or fillers include, but are not limited to, extenders; pigment wetting and dispersing agents and surfactants; anti-settling, anti-sag and bodying agents; anti-flooding and anti-floating agents; fungicides and mildewcides; corrosion inhibitors; thickening agents; or plasticizers. Non-limiting examples of suitable coating additives can be found in RAW MATERIAL INDEX, published by the National Paint & Coatings Association, 1500 Rhode Island Avenue, NW, Washington, D.C. 20005. Non-limiting examples of suitable colorants include dyes (e.g., solvent red 135), organic pigments (pigment blue 15:1), inorganic pigments (e.g., iron oxide pigment red 101), effect pigments (e.g., aluminum flake), or combinations thereof.

Also disclosed herein is a method for printing or applying a liquid carrier composition on a substrate to form the article disclosed herein. Any of the aforementioned substrates can be used in the methods disclosed herein. The compositions can be applied by drawing, rolling, spraying, printing, or any other method of applying a liquid carrier composition to a substrate.

When present, the liquid carrier typically comprises the majority of the composition and can be added in an amount necessary to achieve the desired viscosity and/or end use properties. In some embodiments, the liquid carrier is present in an amount of from about 10 wt % to about 90 wt %, from about 20 wt % to about 70 wt %, from about 30 wt % to about 60 wt %, and from about 40 wt % to about 60 wt %, based on the total weight of the composition (e.g., an uncured formulation).

### Surfactant and Dispersants

In some embodiments, the composition may include a surfactant or dispersant, which is a surface active material that helps reduce the surface energy between two dissimilar surfaces. This enables those two surfaces to be combined in a way that normally would not be successful. Surfactants and dispersants can be used to disperse a solid material (i.e., a functional metal or halide salt) into a liquid material (i.e., water, solvent, monomer, melted thermoplastic or uncured thermoset). Oftentimes a surfactant or dispersant allows for stabilization of the solid material into the liquid matrix with a smaller particle size, enabling a larger available surface area of the solid material to be available.

The surfactant or dispersant may be selected from one or more of nonionic, anionic, cationic, ampholytic, amphoteric and zwitterionic surfactants. A typical listing of anionic, ampholytic and zwitterioinic classes, and species of these surfactants, is given in U.S. Pat. No. 3,929,678. A list of suitable cationic surfactants is given in U.S. Pat. No. 4,259, 217. Each of these documents is incorporated herein by reference.

Nonionic surfactants are compounds produced by the condensation of an alkylene oxide (hydrophilic in nature) with an organic hydrophobic compound which is usually aliphatic or alkyl aromatic in nature. The length of the hydrophilic or polyoxyalkylene moiety which is condensed with any particular hydrophobic compound can be readily adjusted to yield a water-soluble compound having the desired degree of balance between hydrophilic and hydrophobic elements. Another variety of nonionic surfactant is the semi-polar nonionic typified by the amine oxides, phosphine oxides, and sulfoxides. Examples of suitable nonionic surfactants include the polyethylene oxide condensates of alkyl phenols, the condensation products of aliphatic alcohols with ethylene oxide, the condensation products of ethylene oxide with a hydrophobic base formed by the condensation of propylene oxide with propylene glycol and the condensation products of ethylene oxide with the product resulting from the reaction of propylene oxide and ethylene diamine.

Ampholytic synthetic detergents can be broadly described as derivatives of aliphatic or aliphatic derivatives of heterocyclic secondary and tertiary amines in which the aliphatic radical may be straight chain or branched and wherein one of the aliphatic substituents contains from about 8 to 18 carbon atoms and at least one contains an anionic water-solubilizing group, e.g., carboxy, sulfonate, sulfato. Examples of compounds falling within this definition are sodium 3-(dodecylamino)propionate, sodium 3-(dodecylamino)propane-1-sulfonate, sodium 2-(dodecylamino)ethyl sulfate, sodium 2-(dimethylamino)octadecanoate, disodium 3-(N-carboxymethyldodecylamino)propane-1-sulfonate, disodium octadecyl-iminodiacetate, sodium 1-carboxymethyl-2-undecylimidazole, and sodium N,N-bis(2-hydroxyethyl)-2-sulfato-3-dodecoxypropylamine.

Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. The cationic atom in the quaternary compound can be part of a heterocyclic ring. In all of these compounds there is at least one aliphatic group, straight chain or branched, containing from about 3 to 18 carbon atoms and at least one aliphatic substituent containing an anionic water-solubilizing group, e.g., carboxy, sulfonate, sulfate, phosphate, or phosphonate. Preferred compounds of this class from a commercial standpoint are 3-(N,N-dimethyl-N-hexadecylammonio)-2-hydroxypropane-1-sulfonate; 3-(N,N-dimethyl-N-alkylammonio)-2-hydroxypropane-1-sulfonate, the alkyl group being derived from tallow fatty alcohol; 3-(N,N-dimethyl-N-hexadecylammonio)propane-1-sulfonate; 3-(N,N-dimethyl-N-tetradecylammonio)propane-1-sulfonate; 3-(N,N-dimethyl-N-alkylammonio)-2-hydroxypropane-1-sulfonate, the alkyl group being derived from the middle cut of coconut fatty alcohol; 3-(N,N-dimethyldodecylammonio)-2-hydroxypropane-1-sulfonate; 4-(N,N-dimethyl-tetradecylammonio)butane-1-sulfonate; 4-(N,N-dimethyl-N-hexadecylammonio)butane-1-sulfonate; 4-(N,N-dimethyl-hexadecylammonio)butyrate; 6-(N,N-dimethyl-N-octadecylammonio)hexanoate; 3-(N,N-dimethyl-N-eicosylammonio)-3-methylpropane-1-sulfonate; and 6-(N,N-dimethyl-N-hexadecylammonio)hexanoate.

Anionic surfactants includes ordinary alkali metal soaps such as the sodium, potassium, ammonium and alkylolammonium salts of higher fatty acids containing from about eight to about 24 carbon atoms and preferably from about 10 to about 20 carbon atoms. Suitable fatty acids can be obtained from natural sources such as, for instance, from plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by hydrogenation of carbon monoxide by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful are the sodium and potassium salts of the mixtures of fatty acids derived from coconut oil and tallow, i.e., sodium or potassium tallow and coconut soap. Anionic synthetic detergents include water-soluble salts, particularly the alkali metal salts, of organic sulfuric reaction products having in their molecular structure an alkyl group containing from about 8 to about 22 carbon atoms and a moiety selected from the group consisting of sulfonic acid and sulfuric acid ester moieties. (Included in the term alkyl is the alkyl portion of higher acyl moieties.) Examples of this group of synthetic detergents are the sodium and potassium alkyl sulfates, especially those obtained by sulfating the higher alcohols (e.g., 8 to 18 carbon atoms) produced by reducing the glycerides of tallow or coconut oil; sodium and potassium alkyl benzene sulfonates, in which the alkyl group contains from about 9 to about 20 carbon atoms in straight-chain or branched-chain configuration; sodium alkyl glyceryl ether sulfonates, especially those ethers of higher alcohols derived from tallow and coconut oil; sodium coconut oil fatty acid monoglyceride sulfonates and sulfates. The surfactants may typically be present in an amount of from 0.1 wt % to 15 wt %, such as from 0.1 wt % to 10 wt %, or from 0.1 wt % to 5.0 wt %, based on the total weight of the composition.

### Polymer Masterbatch or Compound

Incorporation of the functional metals and the halide salts of the present disclosure in molded and extruded thermoplastic finished products is generally achieved by first making a masterbatch. A masterbatch is a highly loaded concentrate containing many of the composition components at higher concentrations, which is then further diluted into the composition of the final finished article. Masterbatches are typically used by commercial processors in various molding and/or extrusion operations to make intermediate or final products. These processing methods include injection molding, reactive injection molding, blow molding, blown film processing, profile extrusion, calendaring, thermoforming, film and sheet extrusion, and fiber spinning. For a given masterbatch, processors may use a wide range of masterbatch ratios, depending on the desired level of additive in the final product. Masterbatch concentrations ranging from 0.1 wt % to over 10 wt % based on the total weight of the article are typical, and the masterbatches can be used to make a wide variety of products for various applications. Often, the masterbatch is used to deliver a functionality to the final product. Some examples of such final products include but are not limited to trays, tables, desks, chairs, medical devices, waste containers, personal care items, wound care articles, surgical gloves and masks, textiles, spun fibers, packing and electronics.

In some embodiments, the disclosed technology involves melt mixing a functional metal and a halide salt at an elevated concentration into a polymer and forming that material mixture into pellets. The functional metal and halide salt in their dry state are mixed with the carrier polymer and any other composition components, usually on a roll mill or in a twin screw extruder so all components intimately mix resulting in a high concentration of both the functional metal (antimicrobial agent) and the halide salt. The masterbatch may also contain other additives or components such as one or more anti-block agents, anti-oxidants, anti-stat, UV stabilizers, colorants, lubricants, waxes, dispersants, flame retardants, chain extenders, cross linking agents, laser marking additives, mold release, internal lubricants, slip agents, optical brighteners, flow aids, foaming agents, nucleating agents, plasticizers, colorants, or other polymers, and combinations thereof. The result of making a masterbatch are pellets that can be further processed into the final part. The functional metal and halide salt are typically incorporated at a relatively high combined concentration (1-80 st %, such as 20-80 wt % or 40-80 wt %) in the masterbatch along with a carrier or binder. The carrier or binder may be, but does not need to be, the same as the polymer that it is used in to make the final article.

In cases where the functional metal and halide salt are incorporated with a carrier or binder (i.e., desired polymer) at the desired end-use concentration, the mixture is called a “compound” that is designed to be directly formed into the final part at that concentration. Otherwise, the mixture is still considered a masterbatch if it is subsequently mixed with, or “let down” into, the desired polymer before forming the finished molded or extruded product.

### Antimicrobial Efficacy

In one or more embodiments, the functionality brought by the combination of a functional metal or metals and the halide salt is antimicrobial in nature. As used herein, the term “antimicrobial” refers to a property whereby a material or a surface (e.g., film or coating) of a material is able to kill and/or inhibit the growth of microbes in contact with that material, wherein such microbes may include bacteria, viruses and/or fungi. The term “antimicrobial” as used herein does not mean the material or the surface of the material will kill or inhibit the growth of all species microbes within any particular family or families, but that it will kill or inhibit the growth of one or more species of microbes within such family or families.

As used herein, the term “log reduction” means −log(Ca/Co), where Ca=the colony form unit (CFU) number of the antimicrobial surface and Co=the colony form unit (CFU) of the control surface that is not an antimicrobial surface. As an example, a 3 log reduction equals about 99.9% of the microbes killed and a Log Reduction of 5=99.999% of microbes killed.

In one or more embodiments, the functional article includes copper or copper-containing particles and a halide salt embedded in the functional article or in a coating cured on the functional article. The article surface can be characterized under the CIELAB colorimetry system, light transmission, and optical density compared to articles that only include the copper or copper-containing particles without any halide salt added. In one or more embodiments, the L*-value can drop significantly upon addition of the copper or copper-containing particles. The L*-value is dependent on the loading of the copper or copper-containing particles and can range from about 1 to about 99, from about 5 to about 95, from about 10 to about 90, from 20 to about 80, from 30 to about 70, from 40 to about 60, greater than 50, greater than 60, greater than 70, greater 80, and greater than 90.

Advantageously, upon addition of the halide salt, the effect of the copper or copper-containing particles on the L*-value of the article is significantly reduced. That effect on the L*-value can be measured by comparing the change in the L*-value of an article that contains the halide salt with one that does not. In some embodiments, the article has a higher L* value due to the inclusion of the halide salt in the composition, as compared to an article comprising a composition that differs only by the absence of the halide salt. This DL* is dependent on the loading of the copper or copper-containing particles and can be, for example, less than 10 units, less than 8 units, less than 6 units, less than 4 units, less than 2 units, less than 1 unit, less than 0.5 units, or less than 0.2 units.

In one or more embodiments, the transparency of the article can decrease significantly upon addition of the copper or copper-containing particles, but then advantageously increase with the addition of the halide salt. As used herein, “transparency” is defined as the amount of light in the visible light spectrum (wavelengths of light from about 400 nm to about 750 nm) permitted to pass through the portion of the disclosed functional article in which the disclosed composition is present. This transparency is dependent on the loading of the copper or copper-containing particles and can be, for example, less than 90%, less than 50%, less than 30%, less than 10%, less than 3%, less than 1%, less than 0.1%, or less than 0.01%. In some embodiments, the article has higher transparency due to the inclusion of the halide salt in the composition, as compared to an article comprising a composition that differs only by the absence of the halide salt.

In one or more embodiments, the opacity of the article can increase significantly upon addition of the copper or copper-containing particles, but then advantageously decrease with the addition of the halide salt. Here, opacity is defined as the amount of light in the visible light spectrum (wavelengths of light from about 400 nm to about 700 nm) prevented from passing through the disclosed article. For drawn down films, the opacity of the film can be measured and compared using ASTM D2805, Standard Test Method for Hiding Power of Paints by Reflectometry. In some embodiments, the article has a lower opacity due to the inclusion of the halide salt in the composition, as compared to an article comprising a composition that differs only by the absence of the halide salt. The opacity is dependent on the loading of the copper or copper-containing particles and the decrease in opacity with the addition of a halide salt can range for various samples from a value of greater than 0.5 percentage points, greater than 1.0 percentage point, greater than 2.0 percentage points, greater than 5.0 percentage points, greater than 10 percentage points, greater than 20 percentage points, greater than 40 percentage points, greater than 60 percentage points, greater than 80 percentage points, or greater than 90 percentage points. Upon addition of the halide salt, the article may have lower opacity (e.g., higher transparency or lower contrast ratio).

In one or more embodiments, the haze of the article can increase significantly upon addition of the copper or copper-containing particles, but then advantageously decrease with the addition of the halide salt. As used herein, “haze” refers to an optical effect characterized by a cloudy or milky appearance, and is measured using a BYK Gardner Haze-Gard Plus following ASTM D-1003, Standard Test Method for Haze and Luminous Transmittance of Transparent Plastics. In some embodiments, the article has a lower haze due to the inclusion of the halide salt in the composition, as compared to an article comprising a composition that differs only by the absence of the halide salt. The haze is dependent on the loading of the copper or copper-containing particles and the change in haze with the addition of a halide salt can range for various samples from a value of greater than 0.1 percentage points, greater than 0.5 percentage points, greater than 1.0 percentage points, greater than 5.0 percentage points, greater than 10 percentage points, greater than 20 percentage points, greater than 40 percentage points, or greater than 50 percentage points. Upon addition of the halide salt, the article may have lower haze.

In one or more embodiments, the chroma may increase significantly upon addition of the copper or copper-containing particles, but then advantageously decrease with the addition of the halide salt. In some embodiments, the article has a lower chroma due to the inclusion of the halide salt in the composition, as compared to an article comprising a composition that differs only by the absence of the halide salt. Chroma is dependent on the loading of the copper or copper-containing particles and the change in Chroma with the addition of a halide salt can range from greater than 1.0 unit, greater than 2.0 units, greater than 5.0 units, greater than 10 units, greater than 20 units, greater than 30 units, greater than 40 units, or greater than 50 units. Upon addition of the halide salt, the article may have lower Chroma.

In one of more embodiments, the visual appearance of the functional article may be affected by the addition of a halide salt being incorporated with the functional metal-containing article in a polymer matrix or film. There are multiple ways to assess differences between color values measured with a spectrophotometer and correlate those differences to visual appearance. In some embodiments, a goal is to measure the difference between a displayed color (the sample) and the original color standard. Delta E_{CMC} (DE_{CMC}) provides better agreement between visual assessment and measured color difference than other methods of comparison. It is based on CIELAB data as defined above, but it mathematically defines an ellipsoid around a color standard with semi-axis corresponding to hue (h°), chroma (C*) and lightness (L*). The ellipsoid represents the volume of acceptable color and automatically varies in size and shape depending on the position of the color in color space.

The CMC equation allows for the variation of the overall size of the ellipsoid to better match what is visually acceptable or visually different. This can be done by varying the commercial factor (cf), since the eye accepts larger differences in lightness (l) than chroma (c). The default l:c ratio is typically 2:1 and that is what is used herein unless noted differently.

The color difference between a sample color and a standard reference color is outlined in ASTM D2244, which is incorporated by reference. Samples should be clean, dry and free of deposits. Samples that have some level of transparency, for example a thin clear coating, are measured over a white background with an L* value over 85. Both the sample and the standard should be measured with a spectrophotometer, such as a Ci7800 from X-Rite, and evaluated under the same illuminant and observer. If not mentioned specifically, the default illuminant is D65 and the default observer is CIE 1964 10°.

For such measurements, the difference in color between the sample and the standard reference is considered substantial and thus indicative of a noticeable or large color change if the DE_{CMC} has a value of more than 0.5 units, more than 1 unit, more than 2 units, more than 3 units, more than 4 units, or more than 5 units.

In one or more embodiments, the functional article includes copper or copper-containing particles and a halide salt embedded in the functional article or in a coating cured on the functional article. The article surface can be characterized using methods commonly accepted for antimicrobial efficacy. These methods can change greatly depending on the information desired and the regional accepted methodology for testing antimicrobial performance. For example, proving that an article exhibits sufficient antimicrobial efficacy to enable the claim of a public health benefit under the purview of the United State Environmental Protection Agency (USEPA) requires antimicrobial efficacy of greater than 3 log reduction in Staphylococcus aureous with different test methods depending on the type of article. For example, on Jan. 23, 2020 the USEPA released its Interim Method for the Evaluation of Bactericidal Activity of Hard, Non-Porous Copper-Containing Surface Products. On Oct. 2, 2020 the USEPA released an Interim Method for Evaluating the Efficacy of Antimicrobial Surface Coatings. The existence of both of these methods indicates that the form factor of the article is important, as does language on the USEPA's website that states that deviation from hard surface testing (i.e., fibers or fabrics) requires consultation with USEPA to design and approve testing protocols. Other regions of the world have standards different than the USEPA as well. This makes the use of controls for comparison to the tested article important to distinguish its true efficacy.

In one or more embodiments, the test method used was a modification of ISO 22196 (“modified ISO 22196”), where the modification was no film covering the sample and CFU counting based using swab tests and ATP fluorescence. The organism tested was E. coli (ATCC 8793) with an inoculation level of 1.30×10⁶−1.40×10⁶ CFU. Samples were kept at ambient temperature (26° C.) with a relative humidity of about 36.4% relative humidity. For each variable, 3-5 samples were measured and their results averaged. Clear samples (without any functional metal or halide salt) were used to test initial contamination as a control. Contact time between the sample and the microbe after inoculation was 2 hours, after which the microbes were swabbed and tested.

In one or more embodiments, the antimicrobial efficacy of articles containing the copper or copper-containing particles, as measured using the modified ISO 22196 method, was significantly lower than the articles containing both the copper or copper-containing particles and a halide salt. The log reduction depended on both the concentrations of the copper or copper-containing particles and the halide salt and can range from about 0.02 to about 5 log reduction, from about 0.05 to about 4.5 log reduction, from about 0.25 to about 4.0 log reduction, from about 0.5 to about 3.5 log reduction, and from about 1 to about 3 log reduction. In some embodiments, the disclosed functional article has a greater antimicrobial effect than an article comprising a composition that differs only by the absence of the halide salt. The change in antimicrobial efficacy between samples, using the modified ISO 22196 method, can be expressed as a change in log kill between the two samples and can range from more than 0.25 log kill units difference, more than 0.5 log kill units difference, more than 0.75 log kill units difference, more than 1.00 log kill difference units, more than 1.50 log kill difference units, more than 2.00 log kill difference units, or more than 3.00 log kill difference units.

### Light Blocking

Light blocking or light barrier is a quality characterizing the prevention of light from traveling through a sample over a range of light wavelengths. Light barrier can be measured as the average amount of light prevented from passing through a sample at a given wavelength. Light barrier can also be measured as optical density, which is the −log₁₀ of the ratio of light passing through a sample. This is beneficial for measuring samples with very high light barrier. For example, an optical density of 3 means that 99.9% of the light at a given wavelength is prevented from passing through. The relevant light spectrum that the disclosed article references is not restricted to the visible light spectrum. Indeed, light within the ultraviolet spectrum and infrared spectrum can either be beneficial or detrimental depending on the particular application in which the article is to be used. In some embodiments, the disclosed functional article has greater light barrier, such as greater blocking of UV light, as compared to an article comprising a composition that differs only by the absence of the halide salt.

Ultraviolet light is a major culprit for degradation, whether it be for final finished parts or a cause of skin cancer upon human exposure. Mineral fillers like titanium dioxide or zinc oxide are often used to block harmful UV radiation from reaching a surface that requires protection, but these materials provide a white color that is often aesthetically undesirable. One way this has been addressed is through the addition of polymeric materials that are manufactured to block UV radiation but not visible radiation, resulting in a clear film that still provides protection from UV radiation. However, these materials are often organic and will degrade themselves, and are also often not processable at temperatures that are required for thermoplastics applications like nylon or PET.

In some embodiments of the present disclosure, a functional metal is combined with a halide salt to maintain the UV blocking benefits of the metal but to decrease its overall opacity. The result is a material that degrades much slower over time than organic counterparts, does not have a visible white color characteristic of metal-based UV blockers and can be processed at typical thermoplastic processing temperatures (100° C.-500° C.).

### Infrared Light Absorption

Infrared light can impact how fast or uniformly an article heats up when exposed to radiation. How fast and how uniformly a polymer part reheats may be critical to its performance. For a coating, having a coating that expands and contracts at the same rate as the substrate upon which it is deposited prevents adhesion failure due to thermal expansion. For packaging applications, plastic bottles are often manufactured in two steps, with the first step being the formation of a preform that can then be reheated and blown into bottles of various shapes. In order to blow mold these final bottles, the preform must be reheated prior to stretching and the uniformity of which they are reheated often affects both performance as well as speed of manufacture. If the preform is heated with infrared (IR) light, the amount of reflection or absorption at the surface facing the IR light may be higher than at the surface that does not face the IR light. Uniform temperature throughout a preform or pre-stretched article is thus advantageous, and permits a wider processing window. The disclosed technology is thus particularly beneficial for use in manufacturing methods that require reheating, particularly IR reheating because fillers absorb, scatter or reflect light, reducing the effectiveness of IR reheating. Examples of such fillers are titanium dioxide and other metal oxides, zinc sulfide, aluminum and other pigments and dyes. A reduction of their ability to scatter light—which correlates with their opacity—means such fillers can be incorporated without substantially increasing their contribution to reflection or absorption of IR radiation. Thus, IR light will penetrate the preform more effectively prior to orientation.

In some embodiments of the present disclosure, a functional metal is combined with a halide salt to maintain the benefits of the metal in the package or coating but to decrease its overall opacity. The result is a material that provides more uniform reheat over time when exposed to UV radiation. In some embodiments, the disclosed functional article exhibits greater resistance to IR heat than an article comprising a composition that differs only by the absence of the halide salt.

### Recycle Sorting

In plastics recycling, materials are often sorted using infrared light. The specific absorption signature of a polymer can be used to identify and sort of specific material for collection. For example, high density polyethylene bottles and closures can be identified and separated from other materials so that a relatively contamination free source of high density polyethylene can be recycled. Some high density articles are not suitable for recycling, for example oil bottles may cause challenges due to residual oil in the high density polyethylene bottle. A functional metal that has a distinguishable IR absorption signal may be added to a high density polyethylene bottle. This would allow the IR sorting algorithm to identify an oil bottle as not suitable for high density polyethylene recycling. A functional metal with a halide salt may provide such an IR signature without impacting the color value of the branded bottle.

### Oxygen Scavenging

Oxygen scavengers or oxygen absorbers are added to packaging and other various articles to remove or decrease the level of oxygen that traverses the article. This provides protection from materials that are contained within the article that may be susceptible to degradation through an oxidation mechanism. This is true for polymeric materials, as those materials typically have some free volume—and so some oxygen transfer rate—even though they may at first appear to not allow any sort of penetration. Oftentimes, oxygen absorbers are some sort of metal, for example iron, that converts to iron oxide upon exposure to oxygen. This reaction consumes oxygen as it diffuses through the article to reduce the amount of oxygen that reaches the contents. Ferrous carbonate is often used as an oxygen scavenger.

In some embodiments of the present disclosure, the functional metal used for oxygen scavenging is combined with a halide salt to maintain the benefits of the metal in the package or coating but to decrease its overall opacity or impact on color. The result is a material that provides better oxygen scavenging without sacrificing aesthetics. In some embodiments, the disclosed functional article exhibits increased oxygen scavenging as compared to an article comprising a composition that differs only by the absence of the halide salt.

### Conductivity

In order to impart conductivity to a polymer, enough conductive material must be added until it reaches the percolation point. At the percolation point, a continuous conducting 3-dimensional network has been formed within the polymer, and allows for the flow of electrons through it. Until that point is reached, the surrounding polymer acts as an insulator and prevents the flow of electricity through the material. This means that to get to the electrical conductivity requirement of the part requires a significant concentration of the conductive material, often at the sacrifice of aesthetics and/or clarity. Because these types of conductive metals are often used in applications such as LCD screens or LEDs, increased opacity with a decreased color space is a significant hurdle.

In some embodiments of the present disclosure, a functional metal is combined with a halide salt to allow incorporation of the metal at a high enough concentration to impart necessary conductivity but decrease the contribution to opacity in the article. This allows for conductivities of articles in application spaces that require clarity and wide color spaces that are currently not achievable.

In some embodiments, the halide salt may contribute to electrical conductivity in addition to the metal. In some embodiments, the disclosed functional article exhibits increased electrical conductivity as compared to an article comprising a composition that differs only by the absence of the halide salt.

### EXAMPLES

The disclosed technology is next described by means of examples. The use of these and other examples anywhere in the specification is illustrative only, and in no way limits the scope and meaning of the disclosure or of any exemplified form. Likewise, the invention is not limited to any particular preferred embodiments described herein. Indeed, modifications and variations of the disclosure may be apparent to those skilled in the art upon reading this specification, and can be made without departing from its spirit and scope. The disclosure is therefore to be limited only by the terms of the claims, along with the full scope of equivalents to which the claims are entitled. All injection-molded parts, fibers and polymeric films described in the following examples are considered representative articles, and comparable results are expected for other types of articles—e.g., other containers, sheets, films, pouches, thermoformed parts, etc.

### Example 1

Control 1 and Samples 1-3 are injection-molded articles that were prepared using 0.3 wt % cuprous oxide in a nylon 6 polymer and varying the molar ratio of potassium iodide to cuprous oxide, R, from 0.1 to 10. The samples were compared to a nylon control and were prepared by mixing the composition components into a polymeric masterbatch at concentrations 10-times greater than the final concentrations and then extruding into pellets to ensure uniform mixing of the components. Those pellets were then mixed with virgin nylon 6 polymer and injection molded into 40 mil flat plaques for comparison. L*a*b* color values measured with an X-Rite Ci7 spectrophotometer over a Leneta card. Optical density was measured with an X-Rite 361T optical density densitometer. In addition, the samples were tested for antimicrobial efficacy against E. coli using a modified version of ISO 22196 (Test for Antimicrobial Surfaces). The log kill reduction of each sample was measured 5 times and the average is reported in Table 1 below.

TABLE 1

| | Control | Sample | Sample | Sample |
|---|---|---|---|---|
| Composition | A | 1 | 2 | 3 |
| Nylon 6 (wt %) | 100 | 99.7 | 99.67 | 96.7 |
| Cuprous Oxide (wt %) | 0 | 0.3 | 0.3 | 0.3 |
| Potassium lodide (wt %) | 0 | 0 | 0.03 | 3 |
| L* | 94.188 | 71.235 | 80.931 | 89.651 |
| a* | −0.393 | 9.087 | 3.297 | −1.052 |
| b* | 2.794 | 16.203 | 9.827 | 9.913 |
| Optical Density | 0.04 | 0.20 | 0.15 | 0.06 |
| R Value | 0 | 0 | 0.1 | 10 |
| Antimicrobial log reduction* | 0.04 | 0.02 | 0.04 | 1.52 |

*Calculated using method described in antimicrobial section above

Unsurprisingly, incorporation of the cuprous oxide into the Nylon 6 polymer at 0.3 wt % increases the optical density from 0.04 to 0.20 and decreases the L-value from 94.188 to 71.235. However, surprisingly the addition of the potassium iodide, even at low values of R (0.1) increases the optical density to 0.15 and the L-value to 80.931. This effect is even more pronounced at higher values of R (10), as the L-value is nearly 90 (89.651) and the optical density indicates that the article is nearly as transparent as the nylon itself. Interestingly, the incorporation of potassium iodide with the cuprous oxide at high R values (R=10 in this case) results in the material exhibiting a significant log kill reduction relative to samples that do not contain potassium iodide. Therefore, we have achieved a material that not only displays an optical density approaching that of the Nylon control, but also shows a significant log reduction kill of E. coli under the test conditions. These results are not attainable by using only the cuprous oxide alone. It may now be possible to further increase the log kill reduction by increasing the cuprous oxide content without sacrificing material opacity that would not be achievable without the incorporation of potassium iodide into the material. This enables a skilled formulator to either have a significantly expanded color space with identical levels of copper, or to significantly increase the copper concentration without requiring a necessary shift in color from the functional metal.

### Example 2

Control 1, Sample 4 and Sample 5 are injection-molded articles that were prepared using zinc oxide at 0.25 wt % in a nylon 6 polymer and varying the molar ratio R of halogen to metal from 0 to 10 (Table 2). In this particular example, potassium iodide was used as the halide salt. The samples are compared to a nylon control and were prepared by mixing the composition components and running them through an injection molding machine to form 40 mil flat plaques for comparison. Optical densities were measured for comparison.

TABLE 2

| Composition | Control A | Sample 4 | Sample 5 |
|---|---|---|---|
| Nylon 6 (wt %) | 100 | 99.75 | 94.65 |
| Zinc Oxide (wt %) | 0 | 0.25 | 0.25 |
| Potassium lodide (wt %) | 0 | 0 | 5.1 |
| Optical Density | 0.04 | 0.24 | 0.15 |
| R value | 0 | 0 | 10 |

The incorporation of the zinc oxide into the nylon 6 resulted in a white injection molded chip with significant optical density. However, introduction of potassium iodide significantly increased the transparency of the sample, with a reduction in optical density of nearly 38%. This allows a skilled formulator to either have a significantly expanded color space with identical levels of zinc oxide, or to significantly increase the zinc oxide concentration without requiring an article with higher opacity.

### Example 3

This example provides data corresponding to Controls A-M, comparative Counter-Samples 1-3 and Samples 7-20 that were prepared and analyzed. Table 4 shows the components of these compositions fully dried/cured, including the type of polymer (plus any additional solids from surfactants, dispersants, defoamers, etc.), the functional metal (i.e., copper iodide (Cul), GUARDIANT® copper-containing glass ceramic, or cuprous oxide (Cu₂O)) and the type of halide salt (i.e., potassium iodide, sodium chloride, or calcium chloride).

All waterborne controls, counter-samples and samples were formulated from a liquid concentrate containing the copper active that was then diluted into a liquid letdown containing polymeric and other components. That liquid coating formulation was then deposited onto a substrate and cured by heating/drying. The concentrations presented in Table 4 represent the concentrations in the final, cured film on the substrate, with the understanding that the combination of the substrate and the film constitute the antimicrobial article. Any other additions to the formulation (i.e., surfactants, defoamers, rheology modifiers, etc.) are included in the weight percentage of the polymer matrix in Table 4, with their exact concentrations provided in the text herein.

All energy curable controls, counter-samples and samples were formulated by adding the copper active directly to a liquid coating formulation that was then deposited onto a substrate and cured through application of UV energy. The concentrations presented in Table 4 represent the concentrations in the final, cured film on the substrate, with the understanding that the combination of the substrate and the film constitute the antimicrobial article. Any additions to the formulation (i.e., surfactants, photoinitiators, inhibitors, etc.) are included in the weight percentage of the polymer matrix in Table 4, with their exact concentrations provided in the text herein.

All polyvinylchloride samples were made by mixing the copper active and other materials into the PVC using a 2-roll mill until the components were completely dispersed (maximum of 2-minutes). Additional additives such as waxes and plasticizers are included in the weight percentage of the polymer matrix in Table 4, with their exact concentrations provided in the text herein. Because the PVC thermoplastic contains the copper active throughout, the final PVC-part is considered the antimicrobial article.

### Waterborne Concentrates

Concentrate 1 was made containing cuprous oxide at 20 wt %. Concentrate 1 consists of 20 wt % cuprous oxide (FISHER SCIENTIFIC, Cat. AAA144360E), a 1:1 blend of dispersants (DISPERBYK 190 and DISPERBYK 2012, BYK) added at 9.33 wt % each, a defoamer (AIRASE 5200, EVONIK) added at 0.4 wt % and the remaining 60.94 wt % of the concentrate consists of DI water. All components were added to a Cowles mixer and blended together, then put into an Eiger media mill using 1 mm Yttria media at 60 Hertz for 2 hours.

Concentrate 2 was made containing the copper-containing glass ceramic at 15 wt %. Concentrate 2 consists of 15 wt % copper-containing glass ceramic (GUARDIANT®, Corning, Inc.), a 1:1 blend of dispersants (DISPERBYK 190 and DISPERBYK 2012, BYK) added at 7 wt % each, two defoamers (AIRASE 5200 and SURFYNOL DF110D, Evonik) added at 0.4 wt % and 1.5 wt %, respectively, and three rheology modifiers (BYK420, BYK; ACRYSOL RM-8, DOW CHEMICAL ; BENTONE DY-CE, Elementis) at 0.2 wt %, 3 wt % and 2.55 wt %, respectively, and the remaining 63.4 wt % of the concentrate consisted of DI water. All components except for the rheology modifiers were added to a Cowles mixer and blended together, then put into an Eiger media mill using 1 mm Yttria media at 60 Hertz for 2 hours. After milling, the material was put back into a Cowles mixer and blended with the rheology modifiers until uniform.

Concentrate 3 was made containing cuprous iodide at 15 wt %. Concentrate 3 consists of 15 wt % copper iodide and 14 wt % dispersant (DISPERBYK 190, BYK) and 71 wt % DI water. It was mixed under high shear conditions for two minutes and then added directly to the formula as specified below.

### Waterborne Coatings

Waterborne acrylic coating formulation compositions are shown in Table 3. These acrylic compositions were made by mixing a waterborne acrylic emulsion (JONCRYL 74A, BASF) with multiple cosolvents (DYNOL 810 and DYNOL 960, EVONIK) with varying amounts of one of Concentrates 1, 2 or 3, a halide salt and deionized water making up the remaining amount. The amount of concentrate, amount of halide salt and amount of deionized water was adjusted to ensure the final compositions represented in Table 4 after the film was deposited on a substrate and dried. Any addition of concentrate or halide salt was made by reducing the overall amount of deionized water in the formulation. Halide salts used were the following: KI (PHOTO GRADE), Deepwater Chemicals; Morton® noniodized salt, Walmart; food grade anhydrous 94-97% calcium chloride pellets, Occidental Chemical Corporation.

TABLE 3

| | | Controls B, E and | Controls |
|---|---|---|---|
| | | F; Counter | K and L; |
| | Manu- | Samples 1 and | Samples |
| Material | facturer | 2, Sample 9 | 13-19 |
| JONCRYL 74A | BASF | 51.90% | 40.00% |
| DYNOL 810 | EVONIK | 0.48% | 0.48% |
| DYNOL 960 | EVONIK | 0.77% | 0.77% |
| DISPERSION 1, 2 OR 3 | N/A | Variable | Variable |
| HALIDE SALT (KI, | *See Text | Variable | Var ble |
| NaCl or CaCl₂ | | | |
| DEIONIZED WATER | N/A | Variable | Variable |

The cured acrylic films containing copper iodide (Control B, Counter-Samples 1 and 2) were made by drawing down the acrylic coating formulations using a number 11 wet film applicator rod onto a Form 5DX Leneta Card. The coating formulations were then force dried at 80° C. for 5 minutes and then allowed to dry overnight.

The cured acrylic films containing copper oxide (Control K, Sample 12) and some containing the copper-containing glass ceramic (Control L, Samples 13-19) were made by drawing down films using a number 8 wet film applicator rod onto a Form 5DX Leneta Card. The coating formulations were then force dried at 80° C. for 5 minutes and then allowed to dry overnight.

Other cured acrylic films containing the copper-containing glass ceramic (Controls E and F, Sample 9) were made by drawing down films using a number 8 wet film applicator rod onto a white vinyl substrate (BRITE WHITE 0.010 GAUGE VINYL, OMNI WC). The films were then force dried at 80° C. for 5 minutes and then allowed to dry overnight.

Waterborne polyurethane coating formulations were made using a proprietary letdown consisting of a TEA-neutralized polyurethane acrylate (23.1 wt %), various ethoxylated acetylenic and organic-based gemini surfactants (1.8 wt %), various hydrophobic silica and mineral oil defoamers (1.6 wt %), various glycol ether cosolvents (5 wt %), a slip aid (3 wt %) and various urea and/or ethylene oxide urethane rheology modifiers (2.56 wt %). The remainder of the formulation is made up of Concentrate 2, halide salt and deionized water, wherein the concentration varies depending on the desired final concentration in the cured film. Any addition of concentrate or halide salt is made by reducing the overall amount of deionized water in the formulation.

The cured polyurethane films containing the copper-containing glass ceramic (Controls G and H, Sample 10) were made by drawing down films using a number 8 wet film applicator rod onto a white vinyl substrate (BRITE WHITE 0.010 GAUGE VINYL, OMNI WC). The films are then force dried at 80° C. for 5 minutes and then allowed to dry overnight.

Cured latex paint films containing the copper-containing glass ceramic (Controls C and D, Samples 7 and 8, Counter-Sample 3) were made using a commercially available white paint base (COLORPLACE CLASSIC EXTERIOR PAINT, Walmart), which was then either applied directly (Control C), mixed with Concentrate 2 (Control D), mixed with Concentrate 2 and potassium iodide at various concentrations (Samples 7 and 8), or a 50:50 mixture of potassium iodide and deionized water (Counter-Sample 3) using a Cowles mixing blade. The paint films were then made by drawing down the liquid paints using a 0.003″ WFT Bird Applicator (catalog #AB-635) onto a Form 5DX Leneta Card. The films are then force dried with a heat lamp until the films have no material transfer and then allowed to dry overnight.

### Energy Curable Coatings

The energy curable films containing the copper-containing glass ceramic (Control I, Control J, Sample 11) were made by blending together a clear containing 92 wt % epoxy acrylate, 2 wt % phosphine oxide photoinitiator, 5 wt % vinyl caprolactam, and 0.5 wt % of two inhibitors (BNX-1035, MAYZO and TEGORAD 2250, Evonik). The copper-containing glass ceramic material was added to the clear directly to make Control J and Sample 11. Potassium iodide was solubilized in deionized water in a 1:1 ratio to dissolve and then mixed into the clear along with the copper-containing glass ceramic for Sample 11. The epoxy acrylate films were made by drawing down films using a number 8 wet film applicator rod onto a white vinyl substrate. The films were then passed through a mercury arc lamp with a primary emission wavelength at 365 nm with secondary emission peaks at 315 and 440 nm at 40 feet per minute five times. The maximum intensity range for the UV stations is between 300-500 watts per inch. The resulting films were hard, with no material transfer or tackiness upon touching.

Control M and Sample 20 were made by incorporating a copper-containing ceramic glass material at various concentrations of potassium iodide into polyvinyl chloride (PVC RESIN 1055, Axiall) on a 2-Roll Mill at 220° C. for a maximum of two minutes. Epoxidized soybean oil (PLATHALL® ESO, Hallstar) was added to the PVC at 20 wt % and an ethylene bis(stearamide) wax (AKAWAX C, Aakash) was added (0.35 wt %) to aid in dispersion of the copper material and the potassium iodide. After removal from the roll mills, the samples were allowed to sit overnight and then shaped into a 0.018 in. flat article on a Carver Press at 150° C.

All samples were tested for antimicrobial efficacy against E. coli using a modified version of ISO 22196 (Test for Antimicrobial Surfaces) as described in the antimicrobial section above. The log kill reduction of each sample was measured on three different samples and the average log kill reduction and standard deviation is reported in Table 5 below. The L*a*b* values and DE_{CMC} were also measured for each sample, showing differences in color. For transparent samples, the color measurement was conducted with the white portion of a Form 5DX Leneta card or the white vinyl substrate described above placed behind the sample.

TABLE 4

| | | | | | | Functional Metal | | | | | |
|---|---|---|---|---|---|---|---|---|---|---|---|
| | Polymer type + additional solids | | | | | | Copper | | | | |
| | | | Epoxy | | | | containing | | Halide Salt | | |
| | | | Acrylate | Commercial | | | ceramic | | Potassium | Sodium | Calcium |
| | Acrylic | Polyurethane | (UV) | Paint | PVC | CuI | glass | Cu₂O | Iodide | Chloride | Chloride |
| Control B | 93.08% | — | — | — | — | 6.92% | — | — | | | |
| Counter Sample 1 | 83.30% | — | — | — | — | 6.20% | — | — | 10.50% | — | — |
| Counter Sample 2 | 83.30% | — | — | — | — | 6.20% | — | — | — | 10.50% | — |
| Control C | — | — | — | 100.00% | — | — | — | — | — | — | — |
| Control D | — | — | — | 96.41% | — | — | 3.59% | — | — | — | — |
| Sample 7 | — | — | — | 94.05% | — | — | 3.54% | — | 2.41% | — | — |
| Sample 8 | — | — | — | 90.65% | — | — | 3.47% | — | 5.88% | — | — |
| Counter Sample 3 | — | — | — | 93.79% | — | — | — | — | 6.21% | — | — |
| Control E | 100.00% | — | — | — | — | — | — | — | — | — | — |
| Control F | 93.15% | — | — | — | — | — | 6.85% | — | — | — | — |
| Sample 9 | 83.46% | — | — | — | — | — | 6.14% | — | 10.41% | — | — |
| Control G | — | 100.00% | — | — | — | — | — | — | — | — | — |
| Control H | — | 93.51% | — | — | — | — | 6.49% | — | — | — | — |
| Sample 10 | — | 83.22% | — | — | — | — | 6.23% | — | 10.55% | — | — |
| Control I | — | — | 100.00% | — | — | — | — | — | — | — | — |
| Control J | — | — | 97.00% | — | — | — | 3.00% | — | — | — | — |
| Sample 11 | — | — | 91.49% | — | — | — | 3.16% | — | 5.35% | — | — |
| Control K | 93.47% | — | — | — | — | — | — | 6.53% | — | — | — |
| Sample 12 | 81.19% | — | — | — | — | — | — | 5.67% | 13.14% | — | — |
| Control L | 95.44% | — | — | — | — | — | 4.56% | — | — | — | — |
| Sample 13 | 93.99% | — | — | — | — | — | 4.49% | — | 1.53% | — | — |
| Sample 14 | 92.57% | — | — | — | — | — | 4.42% | — | 3.00% | — | — |
| Sample 15 | 88.58% | — | — | — | — | — | 4.23% | — | 7.19% | — | — |
| Sample 16 | 94.41% | — | — | — | — | — | 4.51% | — | — | 1.08% | — |
| Sample 17 | 92.90% | — | — | — | — | — | 4.44% | — | — | 2.66% | — |
| Sample 18 | 94.45% | — | — | — | — | — | 4.51% | — | — | — | 1.04% |
| Sample 19 | 93.03% | — | — | — | — | — | 4.44% | — | — | — | 2.53% |
| Control M | — | — | — | — | 97.00% | — | 3.00% | — | — | — | — |
| Sample 20 | — | — | — | — | 91.91% | — | 3.00% | — | 5.09% | — | — |

TABLE 5

| | | | | | Antimicrobial Measurements | |
|---|---|---|---|---|---|---|
| | | | | | E. Coli Kill Reduction (Log | |
| | Visual Measurements | | | | Reduction vs. clear | |
| | L* | a* | b* | DE_{CMC} | control) | E. Coli Kill Standard Deviation |
| Control B | 93.73 | −3.37 | 5.73 | — | — | — |
| Counter Sample 1 | 93.24 | −4.41 | 12.83 | 7.11 | — | — |
| Counter Sample 2 | 93.77 | −3.22 | 6.36 | 0.70 | — | — |
| Control C | 95.70 | −1.02 | 2.25 | — | 2.02 | 0.12 |
| Control D | 84.72 | 2.75 | 14.91 | 10.73 | 2.19 | 0.07 |
| Sample 7 | 86.82 | 0.28 | 16.76 | 3.67 | 3.23 | 0.05 |
| Sample 8 | 89.25 | −2.27 | 13.20 | 6.79 | 4.20 | 0.06 |
| Counter Sample 3 | 95.63 | −1.43 | 3.67 | 1.86 | 2.93 | 0.13 |
| Control E | 93.63 | −1.10 | 2.47 | — | 0.20 | 0.19 |
| Control F | 90.54 | −2.00 | 12.10 | 12.09 | 0.28 | 0.15 |
| Sample 9 | 91.11 | −5.10 | 19.42 | 6.20 | 1.89 | 0.21 |
| Control G | 93.67 | −1.16 | 2.56 | — | 0.07 | 0.19 |
| Control H | 90.36 | −1.13 | 12.91 | 12.83 | 1.26 | 0.46 |
| Sample 10 | 91.88 | −3.53 | 11.71 | 3.14 | 3.42 | 0.10 |
| Control I | 93.55 | 0.59 | 7.76 | — | 0.55 | 0.03 |
| Control J | 79.96 | 11.73 | 35.2 | 27.98 | 0.55 | 0.16 |
| Sample 11 | 83.36 | 6.28 | 30.54 | 4.81 | 2.99 | 0.08 |
| Control K | 85.65 | 6.04 | 17.60 | 21.02 | 0.47 | 0.28 |
| Sample 12 | 89.05 | 1.56 | 14.83 | 5.62 | 3.09 | 0.76 |
| Control L | 92.23 | −2.14 | 7.98 | — | 0.78 | 0.17 |
| Sample 13 | 92.12 | −2.83 | 10.34 | 2.20 | 0.97 | 0.05 |
| Sample 14 | 92.25 | −3.73 | 12.67 | 4.45 | 0.98 | 0.10 |
| Sample 15 | 92.39 | −4.51 | 14.84 | 6.53 | 2.02 | 0.08 |
| Sample 16 | 92.28 | −2.19 | 7.68 | 0.30 | 1.75 | 0.16 |
| Sample 17 | 92.35 | −2.48 | 6.87 | 1.19 | 2.28 | 0.05 |
| Sample 18 | 92.19 | −1.88 | 8.37 | 0.51 | 1.73 | 0.11 |
| Sample 19 | 92.13 | −1.69 | 9.38 | 1.47 | 1.84 | 0.01 |
| Control M | 48.92 | 26.19 | 36.36 | — | 0.72 | 0.14 |
| Sample 20 | 47.57 | 24.52 | 34.33 | 1.26 | 2.67 | 0.02 |

### Copper Iodide (CuI) Films

Control B and Counter-Samples 1 and 2 show an acrylic film containing copper iodide (Control B) compared to films containing the same amount of copper iodide but also a halide salt, either potassium iodide (Counter-Sample 1) or sodium chloride (Counter-Sample 2). DE_{CMC} was used to compare the color values of these samples and the first observation was that the addition of the sodium chloride in Counter-Sample 2 does not impact the color much (DE_{CMC} of 0.70 as compared to Control B). However, the addition of the potassium iodide (Counter-Sample 1) changed the color significantly, with a DE_{CMC} of 7.11. Counter-Sample 1 also shows a decrease in L*-value, which indicates that the formulation used to make Counter-Sample 1 prevented the white from the Leneta card to show through the film when compared to Control B, indicating that the halide salt is causing a negative impact on the color of the article. This is clear visually as there is a significant difference that would be readily apparent to either a skilled or unskilled observer between Control B and Counter-Sample 1 that would be described as a significant yellowing, loss in clarity or increase in haze.

### Paints

Control C, Control D, Samples 7 and 8 and Counter-Sample 3 were made with a commercially available white paint base. The DE_{CMC} of Control D was measured in comparison to Control C while the DE_{CMC} of Samples 7 and 8 and Counter-Sample 3 was measured in comparison to Control D. While the technical data sheet for the commercially available paint does not specify, there is some efficacy against E. coli with just the paint itself (Control C). This is likely due to an antimicrobial added to the paint for in-can preservation. Because the control had some kill itself, a clear acrylic film was used as the control for these antimicrobial measurements. When the copper-containing ceramic glass was added at about 3.5 wt % (Control D), there was very little increase in overall antimicrobial kill, but there was a significant change in color, as noted by the large DE_{CMC} (10.73 units) of Control D compared to Control C. This is largely because of the reduction in L-value, as the paint becomes less white with the incorporation of the copper.

Surprisingly, as the potassium iodide was added to the system (Samples 7 and 8) in increasing concentrations, the effect that the copper-containing ceramic glass had on the overall color of the paint was greatly reduced, as illustrated by a DE_{CMC} of 3.67 and 6.79 for Sample 7 and Sample 8, each compared to Control D. This is driven by a significant increase in the L*-value of the paint, as Control C has an L*-value of 95.70 but drops to 84.72 with just the addition of the copper-containing ceramic glass (Control D). However, that L*-value rises to 86.82 (Sample 7) and 89.25 (Sample 8) as the potassium iodide concentration is increased. Thus, the paint films in Samples 7 and 8 is whiter than the paint in Control D, indicating that the halide salt is mitigating the negative impact of color that copper-containing ceramic glass can impart on a system.

Additionally, the films did not lose their functionality as the addition of the potassium iodide surprisingly increased the antimicrobial efficacy of the films significantly (>1 log in both cases). Thus, the addition of the halide salt mitigates or reduces the negative impact of color from the copper-containing ceramic glass material while allowing it to maintain its functionality.

### Waterborne Acrylic Systems

Control E, Control F and Sample 9 were made with a commercially available acrylic emulsion polymer. Control E is the clear acrylic film without any functional metal or halide salt while Control F contains 6.85 wt % of the copper-containing ceramic glass and Sample 9 contains 6.14 wt % of the copper-containing ceramic glass and 10.41 wt % potassium iodide. The DE_{CMC} of Control F was measured in comparison to Control E while the DE_{CMC} of Sample 9 was measured relative to Control F. When the copper-containing ceramic glass was added without the halide salt (Control E), there was very little antimicrobial efficacy (Log kill reduction of 0.28) compared to a significant amount of antimicrobial efficacy after addition of the halide salt (Control F, Log kill reduction of 1.89). Addition of just the copper-containing ceramic glass shows a significant change in color, as noted by the large DE_{CMC} (12.09 units) of Control F relative to Control E. This is largely because of the reduction in L*-value, as the film becomes less transparent with the incorporation of the copper and so the impact of the vinyl it is deposited on becomes more obscured.

Surprisingly, as the potassium iodide is added to the system (Sample 9), the effect that the copper-containing ceramic glass has on the overall color of the film is reduced, as illustrated by a change in the L*-value of a half unit. This is a significant change given the light brown tint of the film and this is clear visually as there is a significant difference that would be readily apparent to either a skilled or unskilled observer between Control F and Sample 9 that would be described as a significant reduction in brown appearance for Sample 9 compared to Control F. This is reflected in a DE_{CMC} of 6.20 between Sample 9 and Control F indicating there is indeed a significant color change with the addition of the potassium iodide. The increase in L*-value indicates that the formulation used to make Sample 9 enables more of the white from the vinyl substrate to show through the film compared to Control F, indicating that the halide salt is mitigating the negative impact of color that copper-containing ceramic glass can impart on a system.

Additionally, the films did not lose their functionality as the addition of the potassium iodide surprisingly increased the antimicrobial efficacy of the films significantly (>1 log). Thus, the addition of the halide salt mitigates or reduces the negative impact of color from the copper-containing ceramic glass material while allowing it to maintain its functionality.

### Waterborne Polyurethane Systems

Control G, Control H and Sample 10 are made with a commercially available polyurethane emulsion polymer. Control G is the clear polyurethane film without any functional metal or halide salt while Control H contains 6.49 wt % of the copper-containing ceramic glass and Sample 10 contains 6.23 wt % of the copper-containing ceramic glass and 10.55 wt % potassium iodide. The DE_{CMC} of Control H was measured in comparison to Control G while the DE_{CMC} of Sample 10 was measured relative to Control H. When the copper-containing ceramic glass was added without the halide salt in Control H, there was good antimicrobial efficacy (Log kill reduction of 1.26). However, the antimicrobial efficacy increased significantly with the addition of the halide salt in Sample 10 (Log kill reduction of 3.42). Addition of just the copper-containing ceramic glass shows a significant change in color, as noted by the large DE_{CMC} (12.83 units) of Control H relative to Control G. This is largely because of the reduction in L*-value, as the film becomes less transparent with the incorporation of the copper and so the impact of the vinyl substrate it is deposited on becomes more obscured.

Surprisingly, as the potassium iodide is added to the system (Sample 10), the effect that the copper-containing ceramic glass has on the overall color of the film is reduced, as illustrated by a change in the L*-value of more than 1.5 units. This is a significant change given the light brown tint of the film and this is clear visually as there is a significant difference that would be readily apparent to either a skilled or unskilled observer between Control H and Sample 10 that would be described as a significant reduction in brown appearance for Sample 10 compared to Control H. This is reflected in a DE_{CMC} of 3.14 between Samples 10 and Control H indicating there is indeed a significant color change with the addition of the potassium iodide. The increase in L*-value indicates that the formulation used to make Sample 10 enables more of the white from the vinyl substrate to show through the film compared to Control H, indicating that the halide salt is mitigating the negative impact of color that copper-containing ceramic glass can impart on a system.

Additionally, the films did not lose their functionality as the addition of the potassium iodide surprisingly increased the antimicrobial efficacy of the films significantly (>1 log). Thus, the addition of the halide salt mitigates or reduces the negative impact of color from the copper-containing ceramic glass material while allowing it to maintain its functionality.

### UV Curable Films

Control I, Control J and Sample 11 are made with a commercially available epoxy-acrylate energy curable resin. Control I is the clear polymer film without any functional metal or halide salt while Control J contains 3.00 wt % of the copper-containing ceramic glass and Sample 11 contains 3.16 wt % of the copper-containing ceramic glass and 5.35 wt % potassium iodide. The DE_{CMC} of Control J was measured in comparison to Control I while the DE_{CMC} of Sample 11 was measured relative to Control J. When the copper-containing ceramic glass was added without the halide salt in Control J, there was limited antimicrobial efficacy (Log kill reduction of 0.55). However, the antimicrobial efficacy increased significantly with the addition of the halide salt in Sample 11 (Log kill reduction of 2.99). Addition of just the copper-containing ceramic glass shows a significant change in color, as noted by the large DE_{CMC} (27.98 units) of Control J relative to Control I. This is largely because of the reduction in L*-value, as the film becomes less transparent with the incorporation of the copper and so the impact of the white vinyl substrate it is deposited on becomes more obscured.

Surprisingly, as the potassium iodide is added to the system (Sample 11), the effect that the copper-containing ceramic glass has on the overall color of the film is reduced, as illustrated by a change in the L*-value of 3.4 units. This is a significant change given the light brown tint of the film and this is clear visually as there is a significant difference that would be readily apparent to either a skilled or unskilled observer between Sample 11 and Control J that would be described as a significant reduction in brown appearance for Sample 11 compared to Control J. This is reflected in a DE_{CMC} of 4.81 between Sample 11 and Control J indicating there is indeed a significant color change with the addition of the potassium iodide. The increase in L*-value indicates that the formulation used to make Sample 11 enables more of the white from the vinyl substrate to show through the film compared to Control J, indicating that the halide salt is mitigating the negative impact of color that copper-containing ceramic glass can impart on a system.

Additionally, the films did not lose their functionality as the addition of the potassium iodide surprisingly increased the antimicrobial efficacy of the films significantly (>1 log). Thus, the addition of the halide salt mitigates or reduces the negative impact of color from the copper-containing ceramic glass material while allowing it to maintain its functionality.

### Copper Oxide in Waterborne Acrylics

Control K and Sample 12 are made with a commercially available acrylic emulsion polymer. Control K contains 6.53 wt % copper oxide (Cu₂O, cuprous oxide) and Sample 12 contains 5.67 wt % cuprous oxide and 13.14 wt % potassium iodide. The DE_{CMC} of Control K was measured in comparison to Control E (a clear acrylic film) while the DE_{CMC} of Sample 12 was measured relative to Control K. When the copper oxide was added without the halide salt (Control K), there was poor antimicrobial efficacy (Log kill reduction of 0.47) which was increased after addition of the halide salt in Sample 12 (Log kill reduction of 3.09). Addition of just the copper oxide shows a significant change in color, as noted by the large DE_{CMC} (21.02 units) of Control K relative to a clear acrylic film control on a Leneta card. This is largely because of the reduction in L*-value, as the film becomes less transparent with the incorporation of the copper and so the impact of the Leneta card it is deposited on becomes more obscured.

Surprisingly, as the potassium iodide is added to the system (Sample 12), the effect that the copper oxide has on the overall color of the film is reduced, as illustrated by a change in the L*-value of 3.4 units. This is a significant change given the brown tint of the film and this is clear visually as there is a significant difference that would be readily apparent to either a skilled or unskilled observer between Control K and Sample 12 that would be described as a significant reduction in brown appearance for Sample 12 compared to Control K. This is reflected in a DE_{CMC} of 5.62 between Sample 12 and Control K indicating there is indeed a significant color change with the addition of the potassium iodide. The increase in L*-value indicates that the formulation used to make Sample 12 enables more of the white from the Leneta card to show through the film compared to Control K, indicating that the halide salt is mitigating the negative impact of color that copper oxide can impart on a system.

Additionally, the films did not lose their functionality as the addition of the potassium iodide surprisingly increased the antimicrobial efficacy of the films significantly. Thus, the addition of the halide salt mitigates or reduces the negative impact of color from the copper oxide while allowing it to maintain its functionality.

### Different Salts

Control L and Samples 13-19 were made with commercially available waterborne acrylic resin. Control L is a film containing just the copper-containing glass ceramic material. Samples 13-15 are films that contain both the copper-containing glass ceramic material as well as varying levels of potassium iodide. Samples 16 and 17 are films that contain both the copper-containing glass ceramic material and varying levels of sodium chloride. Samples 18 and 19 are films that contain both the copper-containing ceramic material and varying levels of calcium chloride. All samples were tested for antimicrobial activity as well as spectrophotometrically, and the DE_{CMC} for Samples 13-19 were all measured relative to Control L.

Regardless of the salt added, the antimicrobial efficacy of Samples 13-19 was higher than Control L, indicating that the addition of the potassium iodide, sodium chloride and calcium chloride each enhanced the copper-containing glass ceramic's functionality. Each sample also showed a color change relative to Control L as well, with every sample showing a DE_{CMC} of >0.51 except for the lower concentration of sodium chloride (DE_{CMC} of 0.30). The color change became significant (DE_{CMC} of 1.19) as the concentration of the sodium chloride was increased.

Thus, the addition of various halide salts (potassium iodide, sodium chloride and calcium chloride) changes the color impact from the copper-containing glass ceramic on the film while allowing it to maintain or improve its functionality.

### PVC

Control M and Sample 20 were made with a commercially available polyvinylchloride (PVC) resin. Control M is a pressed-out film containing just the copper-containing glass ceramic material. Control M and Sample 20 are films that contain both the copper-containing glass ceramic material but Sample 20 contains potassium iodide as well. All samples were tested for antimicrobial activity as well as spectrophotometrically, and the DE_{CMC} for Sample 20 was measured relative to Control M.

Sample 20 showed a color change relative to Control M with a DE_{CMC} of 1.26 as well as an increase in antimicrobial activity. Thus, the addition of the halide salt changes the color impact from the copper-containing glass ceramic on the film while allowing it to maintain or improve its antimicrobial functionality.

### REFERENCES

Tamay et al., “Copper-polymer nanocomposites: An excellent and cost-effective biocide for use on antibacterial surfaces” Materials Science and Engineering C, 69 (2016) pp. 1391-1409

Sunada et al., “Highly efficient antiviral and antibacterial activities of solid-state cuprous compounds” Journal of Hazardous Materials 235-236 (2012) pp. 265-270

Gross et al., “Copper-containing glass ceramic with high antimicrobial efficacy” Nature Communications 10 (2019) 1979

Pramanik et al., “A novel study of antibacterial activity of copper iodide nanoparticle mediated by DNA and membrane damage” Colloids and Surfaces B: Biointerfaces 96 (2012) 50

Palza et al., “Antimicrobial polymer composites with copper micro- and nanoparticles: Effect of particle size and polymer matrix” Bioactive and Compatible Polymers 30 (2015) 366

U.S. Pat. No. 9,913,476

U.S. Pat. No. 10,034,478

U.S. Pat. No. 7,364,756

US Patent Appl. Publ. No. 2016/0128323

Ramette et al., “Thermodynamics of Iodine Solubility and Triiodide Ion Formation in Water and in Deuterium Oxide” J. American Chemical Society, 87:22 (1965) pp. 5001-5005

Kauffman et al., “Purification of Copper (i) Iodide,” In. Inorganic Syntheses, S. L. Holt (Ed.) 1984

Ebewele, “Polymer Science and Technology,” CRC Press, Boca Raton, FL 2000

Santos et al., “Recent Developments in Antimicrobial Polymers: A Review” Materials 9 (2016) 55914) Naghdi, S., Rhee, K. Y., Hui, D., Park, S. J., “A Review of Conductive Metal Nanomaterials as Conductive, Transparent, and Flexible Coatings, Thin Films, and Conductive Fillers: Different Deposition Methods and Applications,” Coatings, 8 (2018) 278

Ethylene Bis Stearamide: PALMOWAX (describing blooming amide waxes) at https://www.tarakchemicals.com/business-ethylene-bis-stearamide.html (Feb 10, 2021).

We claim:

1. A functional article comprising a composition comprising:
a polymer;
copper oxide; and
a halide salt;
wherein the molar ratio of halide salt to copper oxide in the composition is about 0.01 to about 100; and wherein the article has an enhanced property selected from at least one of the following properties as compared to an article comprising a composition that differs only by the absence of the halide salt:
(a) a color difference measured as DE_{CMC} of more than 0.5 units;
(b) increased antimicrobial efficacy;
(c) reduced opacity;
(d) reduced haze; and
(e) increased whiteness.

2. The functional article of claim 1, wherein the polymer is a thermoplastic.

3. The functional article of claim 1 or 2, wherein the thermoplastic comprises nylon, polyvinylchloride, or a combination thereof.

4. The functional article of claim 1, wherein the polymer is a thermoset polymer and the composition is a cured coating.

5. The functional article of claim 4, wherein the thermoset polymer comprises an acrylic or polyurethane.

6. The functional article of any one of claims 1-5, wherein the copper oxide is contained within a ceramic.

7. The functional article of any one of claims 1-6, wherein the copper oxide is contained within a glass ceramic matrix.

8. The functional article of any one of claims 1-5 wherein the copper oxide is derived from cuprous oxide.

9. The functional article of any one of claims 1-8, wherein the halide salt is selected from at least one of potassium iodide, potassium bromide, magnesium chloride, potassium chloride, sodium chloride, sodium iodide, and calcium chloride.

10. The functional article of any one of claims 1-9, wherein the halide salt is potassium iodide.

11. The functional article of any one of claims 1-10, wherein the composition comprises about 0.01 wt % to about 10 wt % copper oxide, based on the total weight of the composition.

12. The functional article of any one of claims 1-11, wherein the composition comprises about 0.01 wt % to about 10 wt % halide salt, based on the total weight of the composition.

13. The functional article of any one of claims 1-10, wherein the molar ratio of halide salt to copper oxide is about 0.1 to about 10.

14. The functional article of any one of claims 1-13, wherein the composition further comprises a colorant.

15. The functional article of any one of claims 1-14, wherein a color difference measured as DE_{CMC} between the functional article and an article comprising a composition that differs only by the absence of the halide salt is more than 0.5 units.

16. The functional article of any one of claims 1-15, wherein the composition exhibits antimicrobial activity that is at least 0.25 log greater than a composition that differs only by the absence of the halide salt.

17. The functional article of any one of claims 1-16, wherein the composition is less opaque than a composition that differs only by the absence of the halide salt.

18. The functional article of any one of claims 1-17, wherein the composition exhibits less haze than a composition that differs only by the absence of the halide salt.

19. The functional article of any one of claims 1-18, wherein the composition is whiter than a composition that differs only by the absence of the halide salt.

20. The functional article of any one of claims 1-19, wherein the article is selected from a bottle, pouch, fibers, film, sheet, and container.

21. A compound comprising:
a thermoplastic;
copper oxide; and
a halide salt;
wherein the molar ratio of halide salt to copper oxide in the compound is about 0.01 to about 100.

22. A method of producing an antimicrobial article, comprising:
(a) preparing a composition comprising: (i) a thermoplastic or thermoset polymer; (ii) copper oxide; (iii) and a halide salt; wherein the composition exhibits at least a 1 log reduction in concentration of Escherichia coli using a modified ISO 22196 test method; and
(b) forming an antimicrobial article from the composition.

23. The method of claim 22, wherein:
(i) the composition comprises a thermoplastic, and step (b) comprises extruding the composition to produce the antimicrobial article; or
(ii) the composition comprises a thermoset polymer, and step (b) comprises formulating the composition with a liquid carrier to form an antimicrobial liquid dispersion, depositing the antimicrobial liquid dispersion onto an article to form an antimicrobial liquid layer, and curing the antimicrobial liquid layer to form the antimicrobial article comprising an antimicrobial film.

24. The method of claim 22 or 23, wherein a color difference measured as DE_{CMC} between the article and an article having a composition that differs only by the absence of the halide salt is more than 0.5 units.

25. The method of claim 22 or 23, wherein a color difference measured as DE_{CMC} between the article and an article having a composition that differs only by the absence of the copper oxide and halide salt is less than a color difference measured as DE_{CMC} between an article having a composition that differs only by the absence of the halide salt and an article having a composition that differs only by the absence of the copper oxide and halide salt.
